(19) United States
(12) Patent Application Publication
(10) Pub. No.: US 2016/0328678 A1
(43) Pub. Date: Nov. 10, 2016

(54) INITIATING SHIPMENT OF AN ITEM USING A MOBILE/WEARABLE DEVICE

(71) Applicant: UNITED PARCEL SERVICE OF AMERICA, INC., Atlanta, GA (US)

(72) Inventor: Robert J. Gillen, Alpharetta, GA (US)

(21) Appl. No.: 14/980,418

(22) Filed: Dec. 28, 2015

Related U.S. Application Data
(60) Provisional application No. 62/158,175, filed on May 7, 2015.

(51) Int. Cl. G06Q 10/08; H04W 4/00

(52) U.S. Cl. CPC G06Q 10/0838; H04W 4/008

(57) ABSTRACT

Various embodiments provide methods, systems, apparatuses, and computer program products for shipping an item. One embodiment provides a method comprising receiving shipping information for the item via a short range wireless communication from a user computing device executing a shipping application. The shipping information comprises (a) consignor identifying information and (b) consignee identifying information. The shipping information is provided by the shipping application. The method further comprises identifying a user computing entity associated with the consignor identifying information; requesting location information from the user computing entity; and processing the location information to determine if the user computing entity is located in the vicinity of the user computing device. Responsive to determining that the user computing entity is located in the vicinity of the user computing device, a shipping record configured to facilitate the transportation and delivery of the item in accordance with the shipping information is generated.

### BACKGROUND

With the explosion of mobile devices, such as smart phones, wearable computing devices, and the like, there is a need for new approaches for initiating, managing, and controlling the shipment of items and performing other actions as desired by users.

Additionally, as social media causes the number of interactions between users who have not met face-to-face to increase, users may desire to be able to send or receive an item without providing his/her addresses to consignees or shippers. Therefore, there is also a need for new approaches for initiating, managing, and controlling the shipment of items and performing other actions as desired by users that provides privacy for the user.

### BRIEF SUMMARY

In general, embodiments of the present invention provide methods, apparatus, systems, computing devices, computing entities, and/or the like.

According to one aspect of the present invention, a method for shipping an item is provided. In one embodiment, the method comprises receiving shipping information for the item via a short range wireless communication from a user computing device executing a shipping application. The shipping information comprises (a) consignor identifying information and (b) consignee identifying information. The shipping information is provided by the shipping application. The method further comprises identifying a user computing entity associated with the consignor identifying information; requesting location information from the user computing entity; and processing the location information to determine if the user computing entity is located in the vicinity of the user computing device. Responsive to determining that the user computing entity is located in the vicinity of the user computing device, a shipping record configured to facilitate the transportation and delivery of the item in accordance with the shipping information is generated.

According to another aspect of the present invention, an apparatus is provided. In one embodiment, the apparatus comprises at least one processor and at least one memory including program code. The at least one memory and the program code are configured to, with the processor, cause the apparatus to at least receive shipping information for an item via a short range wireless communication from a user computing device executing a shipping application. The shipping information comprises (a) consignor identifying information and (b) consignee identifying information. The shipping information is provided by the shipping application. The at least one memory and the program code are further configured to, with the processor, cause the apparatus to identify a user computing entity associated with the consignor identifying information; request location information from the user computing entity; and process the location information to determine if the user computing entity is located in the vicinity of the user computing device. Responsive to determining that the user computing entity is located in the vicinity of the user computing device, a shipping record configured to facilitate the transportation and delivery of the item in accordance with the shipping information is generated.

In yet another aspect of the present invention, a computer program product is provided. In one embodiment, the computer program product comprises at least one non-transitory computer-readable storage medium having computer-readable program code portions stored therein. The computer-readable program code portions comprises an executable portion configured to receive shipping information for an item via a short range wireless communication from a user computing device executing a shipping application. The shipping information comprising (a) consignor identifying information and (b) consignee identifying information. The shipping information is provided by the shipping application. The computer-readable program code portions further comprise an executable portion configured to identify a user computing entity associated with the consignor identifying information; an executable portion configured to request location information from the user computing entity; and an executable portion configured to process the location information to determine if the user computing entity is located in the vicinity of the user computing device. The computer-readable program code portions further comprise an executable portion configured to, responsive to determining that the user computing entity is located in the vicinity of the user computing device, generate a shipping record configured to facilitate the transportation and delivery of the item in accordance with the shipping information.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an overview of a system that can be used to practice embodiments of the present invention.

FIG. 2 is an exemplary schematic diagram of a carrier/transporter computing entity according to one embodiment of the present invention.

FIG. 3 is an exemplary schematic diagram of a user mobile device according to one embodiment of the present invention.

FIGS. 4, 5, 8, 11, and 13 are flowcharts illustrating operations and processes that can be used in accordance with various embodiments of the present invention.

FIGS. 6, 7, 9, 10, and 12 are exemplary user interface views in accordance with various embodiments of the present invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. COMPUTER PROGRAM PRODUCTS, METHODS, AND COMPUTING ENTITIES

Embodiments of the present invention may be implemented in various ways, including as computer program products that comprise articles of manufacture. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### II. EXEMPLARY SYSTEM ARCHITECTURE

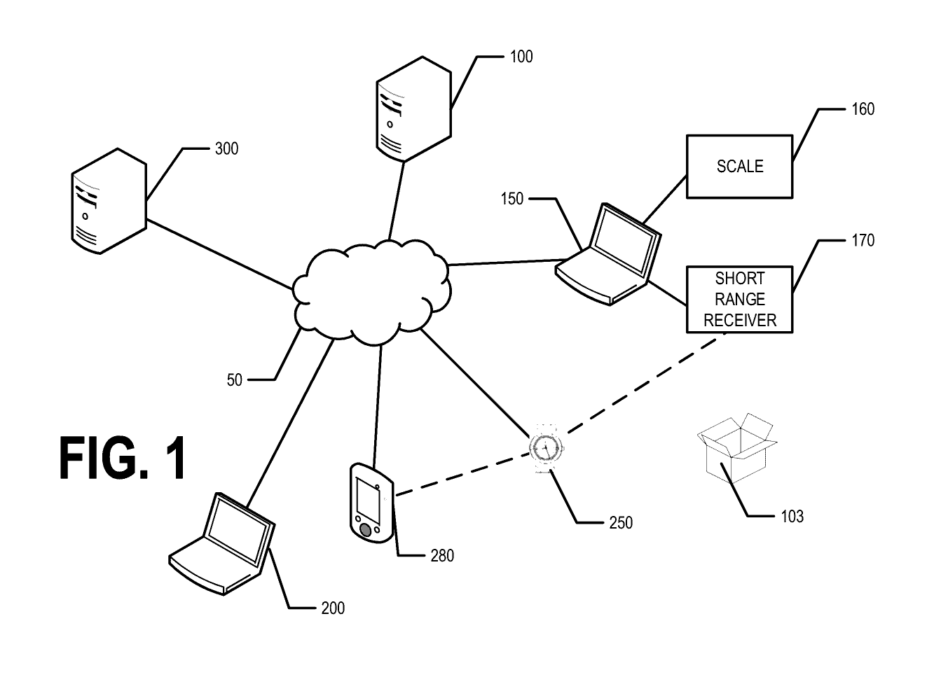

FIG. 1 provides an illustration of an exemplary embodiment of the present invention. As shown in FIG. 1, this particular embodiment may include one or more carrier/transporter computing entities 100, one or more networks 50, one or more establishment computing entities 150, one or more verification computing entities 300, one or more user computing entities 200, one or more wearable computing devices 250, and one or more mobile computing devices 280, and/or one or more mobile entity communications networks (comprising mobile switching centers (MSCs), service control points (SCPs), Home Location Registers (HLRs), Visitor Location Registers (VLRs), and/or the like). Each of these components, entities, devices, systems, and similar words used herein interchangeably may be in direct or indirect communication with, for example, one another over the same or different wired or wireless networks. Additionally, while FIG. 1 illustrates the various system entities as separate, standalone entities, the various embodiments are not limited to this particular architecture.

### 1. Exemplary Item

In one embodiment, an item 103 may be any tangible and/or physical object. In one embodiment, an item 103 may be or be enclosed in one or more packages, envelopes, parcels, bags, goods, products, containers, loads, crates, items banded together, vehicle parts, pallets, drums, the like, and/or similar words used herein interchangeably. In one embodiment, each item 103 may include and/or be associated with an item/shipment identifier, such as an alphanumeric identifier. Such item/shipment identifiers may be represented as text, barcodes, tags, character strings, Aztec Codes, MaxiCodes, Data Matrices, Quick Response (QR) Codes, electronic representations, and/or the like. A unique item/shipment identifier (e.g., 123456789) may be used by the carrier to identify and track the item 103 as it moves through the carrier's transportation network. Further, such item/shipment identifiers can be affixed to items 103 by, for example, using a sticker (e.g., label) with the unique item/shipment identifier printed thereon (in human and/or machine readable form) or an RFID tag with the unique item/shipment identifier stored therein. Such items may be referred to as “connected” items 103 and/or “non-connected” items 103.

In one embodiment, connected items 103 include the ability to determine their locations and/or communicate with various computing entities. This may include the item 103 being able to communicate via a chip or other devices, such as an integrated circuit chip, RFID technology, Near Field Communication (NFC) technology, Bluetooth technology, Wi-Fi technology, and any other suitable communication techniques, standards, or protocols with one another and/or communicate with various computing entities for a variety of purposes. Connected items 103 may include one or more components that are functionally similar to those of the carrier/transporter computing entity 100 and/or the user computing entity 200 as described below. For example, in one embodiment, each connected item 103 may include one or more processing elements, one or more display device/input devices (e.g., including user interfaces), volatile and non-volatile storage or memory, and/or one or more communications interfaces. In this regard, in some example embodiments, an item 103 may communicate send “to” address information/data, received “from” address information/data, unique identifier codes, location information/data, status information/data, and/or various other information/data.

In one embodiment, non-connected items 103 do not typically include the ability to determine their locations and/or might not be able communicate with various computing entities or are not designated to do so by the carrier. The location of non-connected items 103 can be determined with the aid of other appropriate computing entities. For example, non-connected items 103 can be scanned (e.g., affixed barcodes, RFID tags, and/or the like) or have the containers or vehicles in which they are located scanned or located. As will be recognized, an actual scan or location determination of an item 103 is not necessarily required to determine the location of an item 103. That is, a scanning operation might not actually be performed on a label affixed directly to an item 103 or location determination might not be made specifically for or by an item 103. For example, a label on a larger container housing many items 103 can be scanned, and by association, the location of the items 103 housed within the container are considered to be located in the container at the scanned location. Similarly, if a user tenders an item 103 to a carrier by bringing the item to an establishment location, by association, it may be determined that the item 103 is located at the establishment location. These can be referred to as “logical” scans/determinations or “virtual” scans/determinations. Thus, the location of the items 103 is based on the assumption they are within the container or at the establishment location, despite the fact that one or more of such items 103 might not actually be there.

### 2. Exemplary Carrier/Transporter Computing Entity

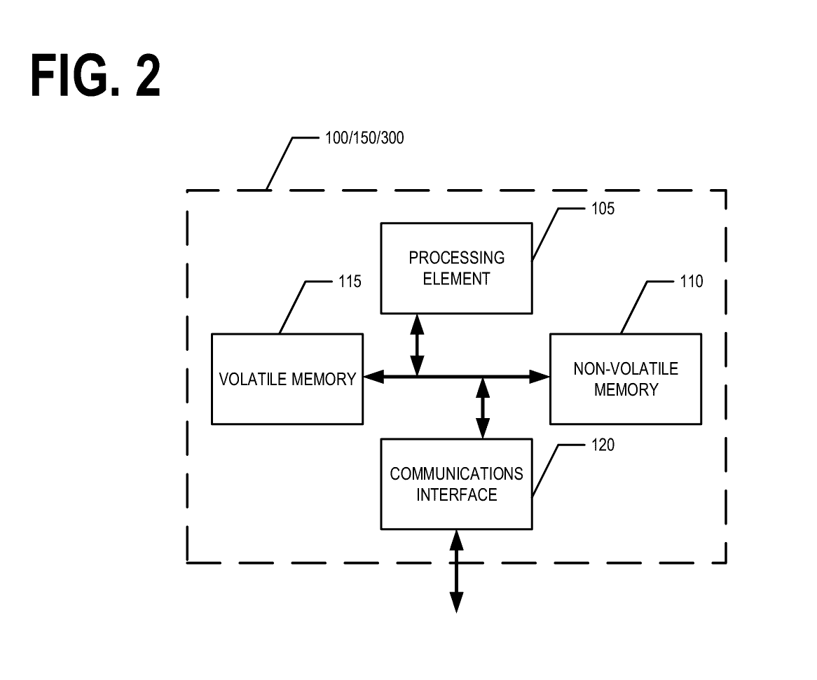

FIG. 2 provides a schematic of a carrier/transporter computing entity 100 according to one embodiment of the present invention. A carrier/transporter may be a traditional carrier/transporter, such as United Parcel Service (UPS), FedEx, DHL, courier services, the United States Postal Service (USPS), Canadian Post, and/or the like. However, a carrier/transporter may also be a nontraditional carrier/transporter, such as Amazon, Google, Uber, ride-sharing services, crowd-source couriers/services, Macy's, and/or the like. In general, the terms computing entity, computer, entity, device, system, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, key fobs, radio frequency identification (RFID) tags, ear pieces, scanners, televisions, vehicles, dongles, cameras, wristbands, wearable items, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

The carrier/transporter computing entity 100 may also comprise, be in communication with, and/or be associated with various other systems, such as an Address Matching System (AMS), an Internet Membership System (IMS), a Customer Profile System (CPS), a Package Center Information System (PCIS), a Customized Pickup and Delivery System (CPAD), a Web Content Management System (WCMS), a Notification Email System (NES), a Fraud Prevention System (FPS), and a variety of other systems and his/her corresponding components. The carrier/transporter computing entity 100 may comprise, be in communication with, and/or be associated with various payment networks/systems/entities for carrying out or facilitating the payment of fees. As will be recognized, the payment of such fees may be in a variety of forms, such as via debit cards, credit cards, direct credits, direct debits, cash, check, money order, Internet banking, e-commerce payment networks/systems/entities (e.g., PayPal, Google Wallet, Amazon Payments), virtual currencies (e.g., Bitcoins), award or reward points, and/or the like.

As indicated, in one embodiment, the carrier/transporter computing entity 100 may also include one or more communications interfaces 120 for communicating with various computing entities, such as by communicating data, content, information, and/or similar terms used herein interchangeably that can be transmitted, received, operated on, processed, displayed, stored, and/or the like.

As shown in FIG. 2, in one embodiment, the carrier/transporter computing entity 100 may include or be in communication with one or more processing elements 105 (also referred to as processors, processing circuitry, and/or similar terms used herein interchangeably) that communicate with other elements within the carrier/transporter computing entity 100 via a bus, for example. As will be understood, the processing element 105 may be embodied in a number of different ways. For example, the processing element 105 may be embodied as one or more complex programmable logic devices (CPLDs), microprocessors, multi-core processors, coprocessing entities, application-specific instruction-set processors (ASIPs), microcontrollers, and/or controllers. Further, the processing element 105 may be embodied as one or more other processing devices or circuitry. The term circuitry may refer to an entirely hardware embodiment or a combination of hardware and computer program products. Thus, the processing element 105 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 105 may be configured for a particular use or configured to execute instructions stored in volatile or non-volatile media or otherwise accessible to the processing element 105. As such, whether configured by hardware or computer program products, or by a combination thereof, the processing element 105 may be capable of performing steps or operations according to embodiments of the present invention when configured accordingly.

In one embodiment, the carrier/transporter computing entity 100 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 110, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the carrier/transporter computing entity 100 may further include or be in communication with volatile media (also referred to as volatile storage, memory, memory storage, memory circuitry and/or similar terms used herein interchangeably). In one embodiment, the volatile storage or memory may also include one or more volatile storage or memory media 115, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 105. Thus, the databases, database instances, database management systems, data, applications, programs, program modules, scripts, source code, object code, byte code, compiled code, interpreted code, machine code, executable instructions, and/or the like may be used to control certain aspects of the operation of the carrier/transporter computing entity 100 with the assistance of the processing element 105 and operating system.

As indicated, in one embodiment, the carrier/transporter computing entity 100 may also include one or more communications interfaces 120 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the carrier/transporter computing entity 100 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Wibree, Bluetooth protocols, wireless universal serial bus (USB) protocols, and/or any other wireless protocol.

Although not shown, the carrier/transporter computing entity 100 may include or be in communication with one or more input elements, such as a keyboard input, a mouse input, a touch screen/display input, motion input, movement input, audio input, pointing device input, joystick input, keypad input, and/or the like. The carrier/transporter computing entity 100 may also include or be in communication with one or more output elements (not shown), such as audio output, video output, screen/display output, motion output, movement output, and/or the like.

As will be appreciated, one or more of the carrier/transporter computing entity's 100 components may be located remotely from other carrier/transporter computing entity 100 components, such as in a distributed system. Furthermore, one or more of the components may be combined and additional components performing functions described herein may be included in the carrier/transporter computing entity 100. Thus, the carrier/transporter computing entity 100 can be adapted to accommodate a variety of needs and circumstances. As will be recognized, these architectures and descriptions are provided for exemplary purposes only and are not limiting to the various embodiments.

### 3. Exemplary Establishment Computing Entity

In various embodiments, the establishment computing entity 150 may be associated with and/or located at an establishment location operated by and/or associated with a carrier or transporter. For example, the establishment computing entity 150 may be located at and/or associated with a post office operated by the USPS, a UPS store, and/or the like. The establishment location need not be operated by and/or associated with the same carrier or transporter as the carrier/transporter computing entity 100. In one embodiment, the establishment computing entity 150 is associated with and/or located at a convenience store, drug store, and/or other establishment that may or may not have shipping lockers located thereat. In one embodiment, an establishment computing entity 150 may include one or more components that are functionally similar to those of the carrier/transporter computing entity 100, verification computing entity 300, wearable computing device 200, mobile computing device 250, and/or the like. For example, in one embodiment, each establishment computing entity 150 may include one or more processing elements (e.g., CPLDs, microprocessors, multi-core processors, coprocessing entities, ASIPs, microcontrollers, and/or controllers), one or more display device/input devices (e.g., including user interfaces), volatile and non-volatile storage or memory, and/or one or more communications interfaces. For example, the user interface may be a user application, browser, user interface, and/or similar words used herein interchangeably executing on and/or accessible via the establishment computing entity 150 to interact with and/or cause display of information/data from various other entities.

In various embodiments, the establishment computing entity 150 may comprise and/or be in communication with a physical input device 160. In various embodiments, the physical input device 160 may comprise a scale, dimensional weight scale, sensors, and/or the like configured to capture physical information/data associated with an item. For example, the physical input device 160 may be configured to have an item placed thereon and to determine the weight, dimensions, environmental status (e.g., temperature) and/or the like of the item placed thereon. For example, an item may be placed on the physical input device 160 and the physical input device 160 may transmit a signal to the establishment computing entity 150 (or that carrier/transporter computing entity 100) indicating the weight, dimensions, and/or environmental status of the item placed thereon. In various embodiments, the physical input device 160 may comprise and/or be in communication with a location sensor (e.g., a GPS receiver). The physical input device 160 may be configured to provide location information/data to the establishment computing entity 150 and/or carrier/transporter computing entity 100 indicating the physical location of the physical input device 160. In various embodiments, the establishment computing entity 150 may comprise and/or be in communication with a short range receiver 170. The short range receiver 170 may be configured to receive short range wireless communications transmitted via Bluetooth, Bluetooth low energy, near field communication, ZigBee, infrared, ultra-wideband, and/or other short range communication method. For example, the short range receiver 170 may receive a short range communication comprising shipping information/data (e.g., from the wearable computing device 200, mobile computing device 250, and/or the like) and provide the shipping data/information to the establishment computing entity 150 (or the carrier/transporter computing entity 100). As will be recognized, these architectures and descriptions are provided for exemplary purposes only and are not limiting to the various embodiments.

### 4. Exemplary User Computing Entity

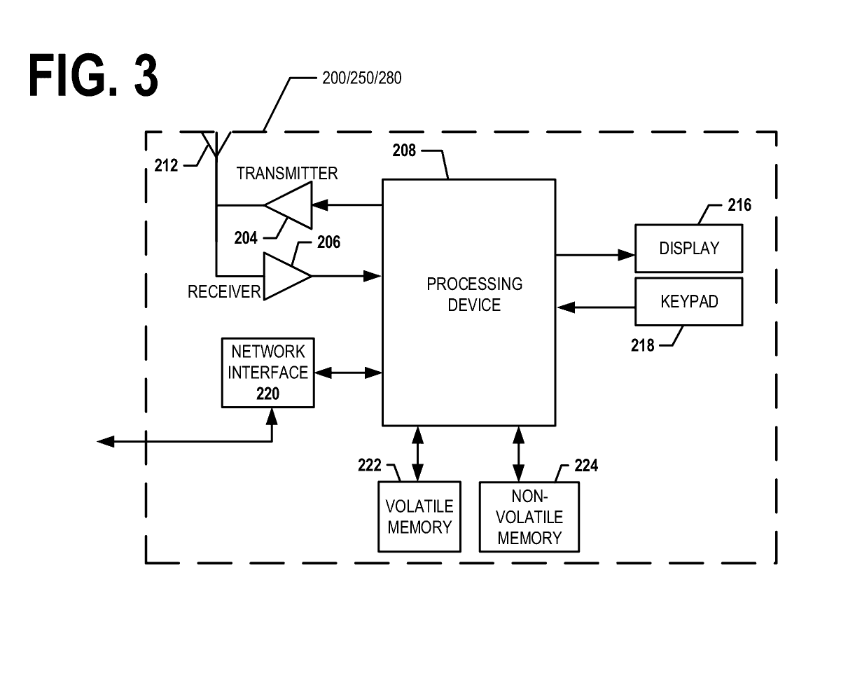

A user may be an individual, a family, a company, an organization, an entity, a department within an organization, a representative of an organization and/or person, and/or the like. To do so, a user may operate a user computing entity 200 that includes one or more components that are functionally similar to those of the carrier/transporter computing entity 100. In various embodiments, a user may be a shipper/consignor of an item or a consignee/recipient to whom an item is to be delivered. In various embodiments a user may be a shipper/consignor of a first item and a consignee/recipient to whom a second item is to be delivered. FIG. 3 provides an illustrative schematic representative of a user computing entity 200 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, key fobs, RFID tags, ear pieces, scanners, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. As shown in FIG. 3, the user computing entity 200 can include an antenna 212, a transmitter 204 (e.g., radio), a receiver 206 (e.g., radio), and a processing element 208 (e.g., CPLDs, microprocessors, multi-core processors, coprocessing entities, ASIPs, microcontrollers, and/or controllers) that provides signals to and receives signals from the transmitter 204 and receiver 206, respectively.

The signals provided to and received from the transmitter 204 and the receiver 206, respectively, may include signaling information/data in accordance with air interface standards of applicable wireless systems. In this regard, the user computing entity 200 may be capable of operating with one or more air interface standards, communication protocols, modulation types, and access types. More particularly, the user computing entity 200 may operate in accordance with any of a number of wireless communication standards and protocols, such as those described above with regard to the carrier/transporter computing entity 100. In a particular embodiment, the user computing entity 200 may operate in accordance with multiple wireless communication standards and protocols, such as UMTS, CDMA2000, 1×RTT, WCDMA, GSM<EDGE, TD-SCDMA, LTE, E-UTRAN, EVDO, HSPA, HSDPA, Wi-Fi, Wi-Fi Direct, WiMAX, UWB, IR, NFC, Bluetooth, USB, Bluetooth low energy, ZigBee, near field communication, infrared, ultra-wideband, and/or the like. Similarly, the user computing entity 200 may operate in accordance with multiple wired communication standards and protocols, such as those described above with regard to the carrier/transporter computing entity 100 via a network interface 220.

Via these communication standards and protocols, the user computing entity 200 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The user computing entity 200 can also download changes, add-ons, and updates, for instance, to its firmware, software (e.g., including executable instructions, applications, program modules), and operating system.

According to one embodiment, the user computing entity 200 may include location determining aspects, devices, modules, functionalities, and/or similar words used herein interchangeably. For example, the user computing entity 200 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the user computing entity's 200 position in connection with a variety of other systems, including wireless towers, Wi-Fi access points, and/or the like. Similarly, the user computing entity 200 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, wireless towers, nearby computing devices (e.g., smartphones, laptops) and/or the like. For instance, such technologies may include the iBeacons, Gimbal proximity beacons, Bluetooth Low Energy (BLE) transmitters, NFC transmitters, infrared transmitters, ZigBee transmitters, ultra-wideband transmitters, and/or the like. These indoor positioning aspects can be used in a variety of settings to determine the location of someone or something to within inches or centimeters.

The user computing entity 200 may also comprise a user interface (that can include a display 216 coupled to a processing element 208) and/or a user input interface (coupled to a processing element 208). For example, the user interface may be a user application, browser, user interface, and/or similar words used herein interchangeably executing on and/or accessible via the user computing entity 200 to interact with and/or cause display of information/data from the carrier/transporter computing entity 100, as described herein. The user input interface can comprise any of a number of devices or interfaces allowing the user computing entity 200 to receive data, such as a keypad 218 (hard or soft), a touch display, voice/speech or motion interfaces, or other input device. In embodiments including a keypad 218, the keypad 218 can include (or cause display of) the conventional numeric (0-9) and related keys (#, *), and other keys used for operating the user computing entity 200 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The user computing entity 200 can also include volatile storage or memory 222 and/or non-volatile storage or memory 224, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the user computing entity 200. As indicated, this may include a user application that is resident on the entity or accessible through a browser or other user interface for communicating with the carrier/transporter computing entity 100, mobile computing device 280, wearable computing device 250, and/or various other computing entities.

In various embodiments, the user computing entity may comprise a short range transmitter for transmitting short range wireless communications via Bluetooth, Bluetooth Low Energy, NFC, infrared, ZigBee, ultra-wideband, and/or the like. For example, user computing entity 200 may be configured to transmit a short range wireless communication that may be received by the short range receiver 170.

In another embodiment, the user computing entity 200 may include one or more components or functionality that are the same or similar to those of the carrier/transporter computing entity 100, as described in greater detail above. In various embodiments, the user computing entity 200 may be a mobile computing device 280 and/or a wearable computing device 250. As will be recognized, these architectures and descriptions are provided for exemplary purposes only and are not limiting to the various embodiments.

### 5. Exemplary Wearable Computing Device

In various embodiments, a user may operate a wearable computing device 250. For example, a wearable computing device 250 may be a smart watch, a heads up display, and/or other wearable computing device. In one embodiment, a wearable computing device 250 may include one or more components that are functionally similar to those of the carrier/transporter computing entity 100, the user computing entity 200, the mobile computing device 280, the establishment computing entity 150, verification computing entity 300, and/or the like. For example, in one embodiment, each wearable computing device 250 may include one or more processing elements (e.g., CPLDs, microprocessors, multi-core processors, coprocessing entities, ASIPs, microcontrollers, and/or controllers), one or more display device/input devices (e.g., including user interfaces), volatile and non-volatile storage or memory, a short range transmitter, and/or one or more communications interfaces. For example, the user interface may be a user application, browser, user interface, and/or similar words used herein interchangeably executing on and/or accessible via the wearable computing device 250 to interact with and/or cause display of information/data from various other entities. In various embodiments, a wearable computing device 250 may be paired with a mobile computing device 280, as generally known and understood in the art. As will be recognized, these architectures and descriptions are provided for exemplary purposes only and are not limiting to the various embodiments.

### 6. Exemplary Mobile Computing Device

In various embodiments, a user may operate a mobile computing device 280. For example, a mobile computing device 280 may be a smart phone, personal data assistant, tablet, phablet, and/or other mobile computing device. In one embodiment, a mobile computing device 280 may include one or more components that are functionally similar to those of the carrier/transporter computing entity 100, the user computing entity 200, the establishment computing entity 150, the wearable computing device 250, verification computing entity 300, and/or the like. For example, in one embodiment, each mobile computing device 280 may include one or more processing elements (e.g., CPLDs, microprocessors, multi-core processors, coprocessing entities, ASIPs, microcontrollers, and/or controllers), one or more display device/input devices (e.g., including user interfaces), volatile and non-volatile storage or memory, a short range transmitter, and/or one or more communications interfaces. For example, the user interface may be a user application, browser, user interface, and/or similar words used herein interchangeably executing on and/or accessible via the mobile computing device 280 to interact with and/or cause display of information/data from various other entities. In various embodiments, a mobile computing device 280 may be paired with one or more wearable computing devices 250, as generally known and understood in the art. As will be recognized, these architectures and descriptions are provided for exemplary purposes only and are not limiting to the various embodiments.

### 7. Exemplary Verification Computing Entity

In various embodiments, the verification computing entity 300 may be associated with a third party service provider such as a telephone service provider, a social media hosting server, an email server, a carrier or transporter, a banking service provider, a text network, and/or the like. For example, the verification computing entity 300 may be operated by and/or on behalf of a telecommunications company that provides telephone service (e.g., public switched telephone network (PSTN) telephone service, voice over internet protocol (VOIP) telephone service, cellular/mobile telephone service, and/or the like). In another example, the verification computing entity 300 may be operated by and/or on behalf of a carrier or transporter such as the USPS or Amazon, or a banking service provider such as a bank that has issued a credit card or debit card to a user, and/or the like. In another example, the verification computing entity 300 may be operated by and/or on behalf of a social media provider with which the user has a social media account. For example, the verification computing entity 300 may be operated by and/or on behalf of Facebook, LinkedIn, Google+, Pinterest, Microsoft Yammer, VMWare Socialcast, IBM Connections, SalesForce Chatter, Twitter, KaKao Talk, WhatsApp, WeChat, Yo, Etsy, Twitter, Instagram, Vine, Snapchat, YouTube, Qzone, Sina Weibo, Tumblr, LINE, WeChat, Ubisoft, and/or the like. In some embodiments, the verification computing entity 300 may be operated by and/or behalf of a newspaper or magazine (or publisher thereof) to which the user has a subscription, and/or other media service provider. Thus, in various embodiments, one or more verification computing entities 300 may be operated by and/or on behalf of service providers of whom the user is a client, user, customer, and/or the like. For example, the verification computing entity 300 may store and/or have access to information/data comprising an address for the user stored in association with user identifying information/data (e.g., a telephone number, handle, username, email address, and/or the like).

In one embodiment, a verification computing entity 300 may include one or more components that are functionally similar to those of the carrier/transporter computing entity 100, establishment computing entity 150, wearable computing device 200, mobile computing device 250, and/or the like. For example, in one embodiment, each verification computing entity 300 may include one or more processing elements (e.g., CPLDs, microprocessors, multi-core processors, coprocessing entities, ASIPs, microcontrollers, and/or controllers), one or more display device/input devices (e.g., including user interfaces), volatile and non-volatile storage or memory, and/or one or more communications interfaces. For example, the user interface may be a user application, browser, user interface, and/or similar words used herein interchangeably executing on and/or accessible via the verification computing entity 300 to interact with and/or cause display of information/data from various other entities.

### 8. Exemplary Mobile Entity Communications Networks

In one embodiment, the mobile entity communications networks for wireless services may include one or more MSCs, SCPs, VLRs, HLRs, call servers, and/or the like. The mobile entity communications networks may be owned and/or operated by entities, such as China Mobile, Vodafone, Telefonica, T-Mobile, Verizon, AT&T, Qtel, China Unicom, Airtel, Etisalat, and/or the like. The MSCs, SCPs, call servers, and/or the like may include one or more components that are functionally similar to those described above with respect to the carrier/transporter computing entity 100, the establishment computing entity 150, the user computing entity 200, wearable computing device 250, the mobile computing device 280, and/or the verification computing entity 300. For example, in one embodiment, entities in the mobile entity communications networks may each include one or more (1) processing elements, (2) memory storage areas, (3) network interfaces, (4) antennae, (5) transceivers, (6) communication interfaces, and/or (7) other components. In one embodiment, although not shown, the MSC may be connected to one or more radio access networks (RAN), including one or more one or more base station controllers (BSC) and one or more base transceiver stations (BTS). As will be recognized, the mobile entity communications networks may support a variety of network types (e.g., wired, wireless, and/or the like) and various communications standards and protocols (e.g., UMTS, CDMA2000, 1×RTT, WCDMA, TD-SCDMA, LTE, E-UTRAN, EVDO, HSPA, HSDPA, Wi-Fi, WiMAX, UWB, Customized Application of Mobile Enhanced Logic (CAMEL), Session Initiation Protocol (SIP), Wireless Intelligent Network (WIN), and/or the like).

### III. EXEMPLARY SYSTEM OPERATION

Various embodiments of the present invention allow a user to quickly and efficiently provide electronic shipping information/data to establishment computing entities 150 and/or carrier/transporter computing entities 100. For example, a user may establish one or more shipping profiles via a shipping application installed on the user's mobile computing device 280 and/or wearable computing device 250 that may be communicated to and stored by the carrier/transporter computing entity 100. The user's mobile computing device 280 and/or wearable computing device 250 may provide the electronic shipping information/data to the establishment computing entity 150 and/or carrier/transporter computing entity 100 when the user tenders the package to a clerk/customer assisting individual or unmanned item receiver. Thus, embodiments of the present invention allow the user to quickly and efficiently provide the electronic shipping information/data corresponding to the item to the establishment computing entity 150 without introducing errors caused by the user filling out a form and the form being manually entered to the establishment computing entity 150. In various embodiments, the shipping application may be configured to facilitate a user shipping an item via multiple carriers and/or internationally.

Additionally, various embodiments of the present invention allow a shipper/consignor or consignee/recipient of an item to maintain his/her privacy by allowing the shipper/consignor to ship an item using a phone number, user name, handle, and/or the like to identify the shipper/consignor and/or consignee/recipient of the item. The carrier/transporter computing entity 100, upon receipt of the electronic shipping information/data, may request verification of at least a part of the shipper/consignor and/or consignee/recipient information/data provided with the electronic shipping information/data. In various embodiments, requesting the verification may comprise requesting an address for the shipper/consignor and/or consignee/recipient of the item based on the provided shipper/consignor and/or consignee/recipient identifying information/data. Thus, embodiments of the present invention allow for automatic verification of the shipper/consignor and/or consignee/recipient information/data of electronic shipping information/data corresponding to an item, including requesting and/or verifying an address to which the item is to be delivered (e.g., the consignee's address). Therefore, embodiments of the present invention are configured to harness the network of computer systems storing information/data associated with a shipper/consignor and/or consignee/recipient of an item to maintain the privacy of the shipper/consignor and/or consignee.

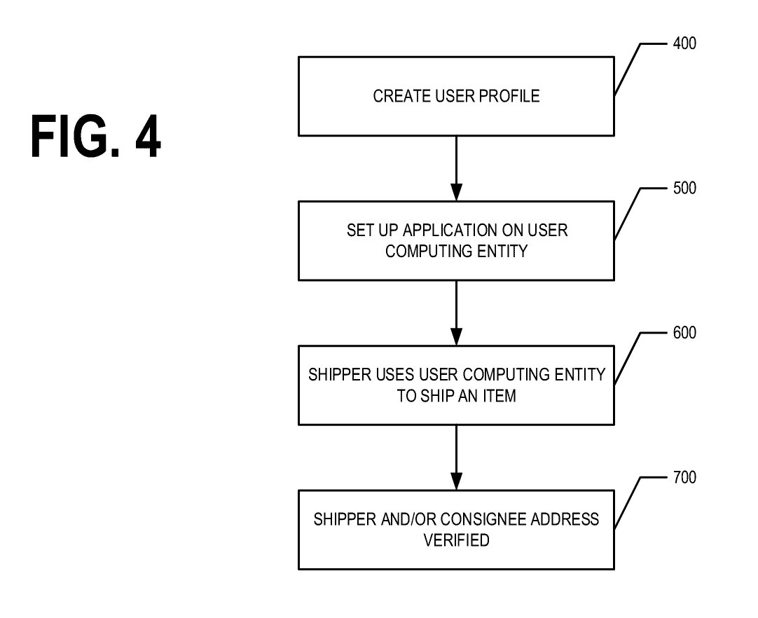

FIG. 4 provides a high level flowchart illustrating an overview of some of the processes and operations that can be used in accordance with various embodiments of the present invention. Starting at step 400, one or more users may create or establish a user profile. For example, a user (e.g., operating a user computing entity 200) access a website, application, and/or the like provided by the carrier/transporter computing entity 100 to create or establish a user profile. At step 500, one or more users may install and set up a shipping application. For example, the carrier/transporter computing entity 100 may provide a shipping application. The user (e.g., operating a user computing entity 200) may download the shipping application and install the shipping application on the user computing entity 200 (e.g., a wearable computing device 250 and/or a mobile computing device 280). The user may then provide various information/data to the shipping application via a user interface provided thereby to create or establish one or more shipping profiles.

At step 600, a user may use a user computing entity 200 to ship an item. For example, a user may arrive at an establishment location with an item and a user computing entity 200 (e.g., a wearable computing device 250 and/or a mobile computing device 280). The user may provide the item to an employee or associate of the establishment location and may provide shipping information/data to the establishment computing entity 150 through a short range communication transmitted from the user computing entity 200 (e.g., a wearable computing device 250 and/or a mobile computing device 280) to the short range receiver 170. In various embodiments, the shipping information/data may include shipper/consignor identifying information/data, consignee/recipient identifying information/data, and/or other shipping information/data (e.g., shipping location identifying information, transport carrier identifying information, or third party identifying information (i.e. mobile phone company, text network, social network, etc.)). In various embodiments, the shipper/consignor identifying information/data and/or the consignee/recipient identifying information/data may be a telephone number, handle, email address, username, and/or the like associated with the shipper/consignor or consignee, respectively. In some embodiments, the consignee/recipient identifying information/data does not comprise an address to which the item is to be delivered.

At step 700, the shipper/consignor and/or consignee/recipient identifying information/data and/or an address associated with the shipper/consignor and/or consignee/recipient may be verified. For example, in some embodiments, when a user creates or establishes a user profile, the information/data provided (e.g., the user address, billing information/data, and/or the like) may be verified. However, if the shipper/consignor or the consignee/recipient corresponding to an item does is not associated with a user profile, the shipper/consignor and/or consignee/recipient identifying information/data may be verified after receiving the shipping information/data for the item. For example, the shipper/consignor and/or consignee/recipient identifying information/data may be verified in response to receiving the shipping information/data for the item. In some embodiments, the consignee/recipient identifying information/data does not comprise an address to which the item is to be delivered. Thus, verifying the consignee/recipient identifying information/data may comprise requesting an address for the consignee. For example, the carrier/transporter computing entity 100 may provide or transmit a verification request to a verification computing entity 300 to request verification of shipper/consignor and/or consignee/recipient identifying information/data and/or an address associated with the shipper/consignor and/or consignee. For example, if the user identifying information/data is a telephone number, the telephone service provider associated with the telephone number (e.g., a verification computing entity 300 associated with the telephone service provider) may be contacted to verify the consignee/recipient identifying information/data and to acquire/verify an address for the consignee. In various embodiments, an address for the shipper/consignor may also be acquired/verified. Various elements of the system operation will now be described in detail.

### 1. Exemplary Registration/Enrollment

In one embodiment, as indicated in Block 400 of FIG. 4, the process may begin with the enrollment/registration for one or more accounts, services, subscriptions, programs, and/or similar words used herein interchangeably. In one embodiment, an account may be an account for wireless services with wireless service providers, such as an account with China Mobile, Vodafone, Telefonica, T-Mobile, Verizon, AT&T, Qtel, China Unicom, Airtel, Etisalat, and/or the like. An account may be a business or personal social media account, such as an account with Facebook, LinkedIn, Google+, Pinterest, Microsoft Yammer, VMWare Socialcast, IBM Connections, SalesForce Chatter, Twitter, KaKao Talk, WhatsApp, WeChat, Yo, Etsy, Twitter, Instagram, Vine, Snapchat, YouTube, Qzone, Sina Weibo, Tumblr, LINE, WeChat, and/or the like. An account may be a gaming account, such as an account with Ubisoft, Mojang, Blizzard, Capcom, Deepsilver, Zombie Studios, Epic Games, Valve, Carbon Games, Digital Extremes, Klei Entertainment, Riot Games, Frozenbyte, Nvidia Shield, Ouya, Xbox, Xbox 360, Xbox One, Wii, Wii U, PlayStation, PlayStation 2, PlayStation 3, PlayStation 4, 3DO, GameCube, Genesis, Intellivision, Nintendo 64, and/or the like. An account may be an entertainment account, such as an account with AppleTV, Apple, Dish, Amazon Digital Services, AT&T U-verse, DIRECT TV, Google Play, QVC, and/or the like. An account may be for retail services, such as an account with amazon.com, macys.com, dell.com, walmart.com, apple.com, staples.com, amazon.com, bestbuy.com, costco.com, alibaba.com, ebay.com, netflix.com, hulu.com, sears.com, and/or the like. An account may be for payment services, such as PayPal, Google Wallet, Amazon Payments, Booker, Erply, Leaf, Leapset, Micros, Revel, ShopKeep, TouchBistro, Vend, and/or the like. An account may be for pickup, delivery, and/or returns services with a carrier/transporter entity, such as an account with United Parcel Service for My Choice and/or the like. As will be recognized, a variety of different accounts can be used to adapt to various needs and circumstances.

In one embodiment, as part of the enrollment/registration process, a user (e.g., a user or user representative operating a user computing entity 200) may be requested to provide information/data (e.g., including user information/data, user virtual addresses, user physical address and/or geographic location to receive physical packages, biographic information/data, geographic information/data, device or entity information/data, payment information/data, and/or the like). The information/data may be manually input by a user; may be automatically provided by allowing access to other accounts, such as Amazon.com, Facebook, Gmail, Twitter, PayPal, and/or the like; may be automatically collected by various computing entities (including automatic device identification); combinations thereof; and/or other techniques and approaches. For instance, the biographic information/data may include a user ID and/or the user's actual name, such as a first name, a last name, a company name, an entity name, an organization name, and/or the like. As indicated, a user may be an individual, a family, a company, an organization, an entity, a department within an organization, a representative of an organization and/or person, and/or the like. The geographic information/data may also include one or more addresses associated with the user (e.g., street address, city, state, postal code, and/or country). The addresses may be residential or commercial addresses, geocodes, latitude and longitude points, virtual addresses, and/or the like.

In one embodiment, the user information/data may include one or more communication preferences that identify communication formats for communicating with the user. The communication formats may include text messages (e.g., SMS, MMS), email messages, voice messages, video messages (e.g., YouTube, the Vine), picture messages (e.g., Instagram), social media messages (e.g., private social media created internally for entities, business social media (e.g., Yammer, SocialCast), and/or public social media (e.g., Facebook, Instagram, Twitter), emojis, and/or a variety of other messages in various communication formats. In addition to the one or more communication formats, the user (e.g., operating a user computing entity 200) can provide the corresponding electronic destination addresses or user IDs to be used in providing information/data associated with the notification/message services to the user (e.g., email addresses, online handles, phone numbers, usernames, user IDs, etc.). For instance, for text messages, the user may provide one or more wireless phone numbers. For email messages, the user may provide one or more email addresses. And for voice messages, the user may provide one or more wireless or landline phone numbers or other electronic destination addresses to which audio files can be delivered. Additionally, in one embodiment, validation operations can be performed with respect to each input electronic destination address—to ensure accuracy. As will be recognized, a variety of other types of electronic destination addresses can be used to adapt to various needs and circumstances.

In certain embodiments, the user (e.g., a user or user representative operating a user computing entity 200) may be requested to provide payment information/data. As indicated, payments (e.g., the payment information/data) may be in a variety of forms, such as via debit cards, credit cards, direct credits, direct debits, cash, check, money order, Internet banking, e-commerce payment networks/systems (e.g., PayPal, Google Wallet, Amazon Payments), virtual currencies (e.g., Bitcoins), award or reward points, and/or the like. Such payments may be made using a variety of techniques and approaches, including through NFC technologies such as PayPass, Android Beam, S Beam, BLE, and various other contactless payment systems. Further, such payment technologies may include PayPal Beacon, Booker, Erply, Leaf, Leapset, Micros, PayPal Here, Revel, ShopKeep, TouchBistro, Vend, and/or the like.

In one embodiment, device or entity information/data may also be received, provided, detected, assigned, collected, requested, and/or similar words used herein interchangeably as part of the registration/enrollment process. The device or entity information/data may include one or more entity or device identifiers—phone numbers, Subscriber Identity Module (SIM) numbers, Media Access Control (MAC) addresses, International Mobile Subscriber Identity (IMSI) numbers, Internet Protocol (IP) addresses, Mobile Equipment Identifiers (MEIDs), unit identifiers (e.g., GPS unit identifiers, Unique Device Identifiers (UDiDs), mobile identification numbers (MINs), IMSI_S (Short IMSIs), email addresses, usernames, user IDs, Globally Unique Identifiers (GUIDs), Integrated Circuit Card Identifiers (ICCIDs), electronic serial numbers (ESN), International Mobile Equipment Identities (IMEIs), Wi-Fi IDs, RFID tags, and/or the like. The device or entity information/data may include a device's vendor, model, specification authority, version, components, software specification and/or version, person associated with the device, and/or the like. The device or entity information/data may be used to communicate with and/or verify communications to and from the corresponding devices or entities.

In one embodiment, with the appropriate information/data, an appropriate computing entity (e.g., carrier/transporter computing entity 100, user computing entity 200, mobile entity communications network) may create or update an account with a user profile for the user via the enrollment/registration process. Accordingly, an appropriate computing entity (e.g., carrier/transporter computing entity 100, user computing entity 200, mobile entity communications network) may create, store, update, and/or have access to various accounts/user profiles and/or information/data associated with the accounts/user profiles. In addition to at least the information/data described above, each account/user profile may include one or more corresponding usernames, passwords, images, tokens, challenge phrases, reminders, and/or the like (referred to herein as credentials) for accessing accounts/user profiles, applications, services, entities, and/or the like.

As will be recognized, in one embodiment, the user (e.g., operating a user computing entity 200) may provide or allow access to the information/data for the user's contacts, connections, associations, friends, links, followers, and/or similar words used herein interchangeably. The information/data for the user's contacts may be stored by the user's computing entity 200 and/or by various other computing entities. In one embodiment, with access to the information/data for the user's contacts, an appropriate computing entity (e.g., carrier/transporter computing entity 100, user computing entity 200, mobile entity communications network) can carry out or facilitate carrying actions involving the same.

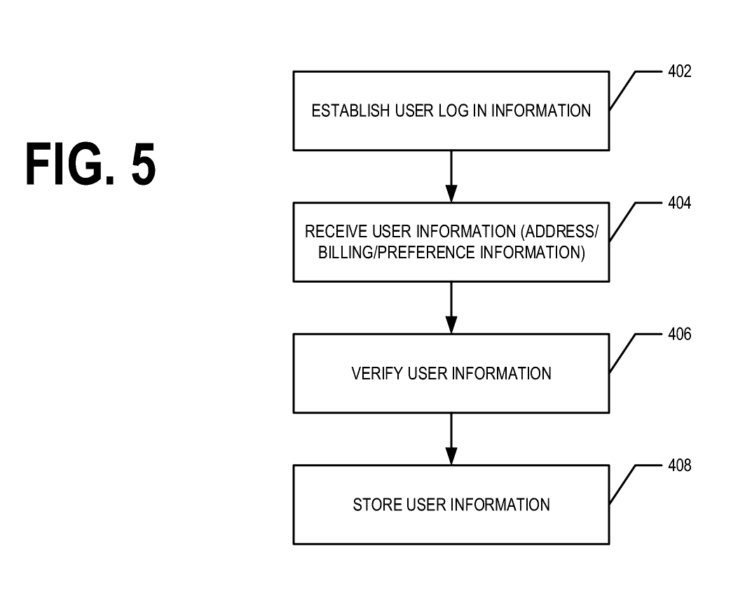

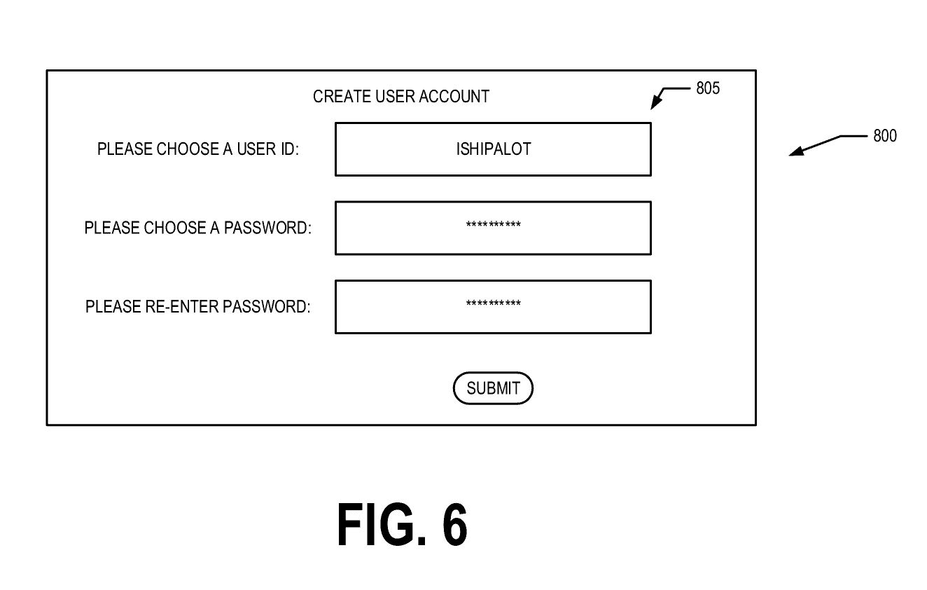

FIG. 5 provides a flowchart of an exemplary user enrollment/registration process through which one or more users may create or establish user profiles. Starting at step 402, a user establishes user log in information/credentials. For example, a user (e.g., operating a user computing entity 200) may provide input to a user interface to establish user log in information/credentials. For example, a carrier/transporter computing entity 100 may provide a shipping application and/or other content to be executed by a shipping application, interface, browser, and/or the like operating on a user computing entity 200 to provide a user interface. The user interface is configured to guide a user in creating or establishing a user profile and to receive user information/data to be stored in association with the user profile. FIG. 6 illustrates an example log in information/credential establishment view 800 of the user interface. The log in information/credential establishment view 800 comprises credential selection form fields 805 and a submit button. The user (e.g., operating the user computing entity 200) may provide input into one or more credential selecting form fields 805 and press/select/click or otherwise interact with the fields to submit and establish the user log in information/credentials. In various embodiments, the log in information/credentials may comprise a username, a password or passcode, security questions and corresponding answers, and/or the like. In various embodiments, the carrier/transporter computing entity 100 may receive the log in information/credentials entered as input into interface, determine if the username is available for use (e.g., not already in use by another user or the like), determine if the passcode meets the passcode requirements (e.g., length, use of numbers, special characters, capitol and/or under case letters), establish a user profile associated with the log in information/credentials, and/or the like.

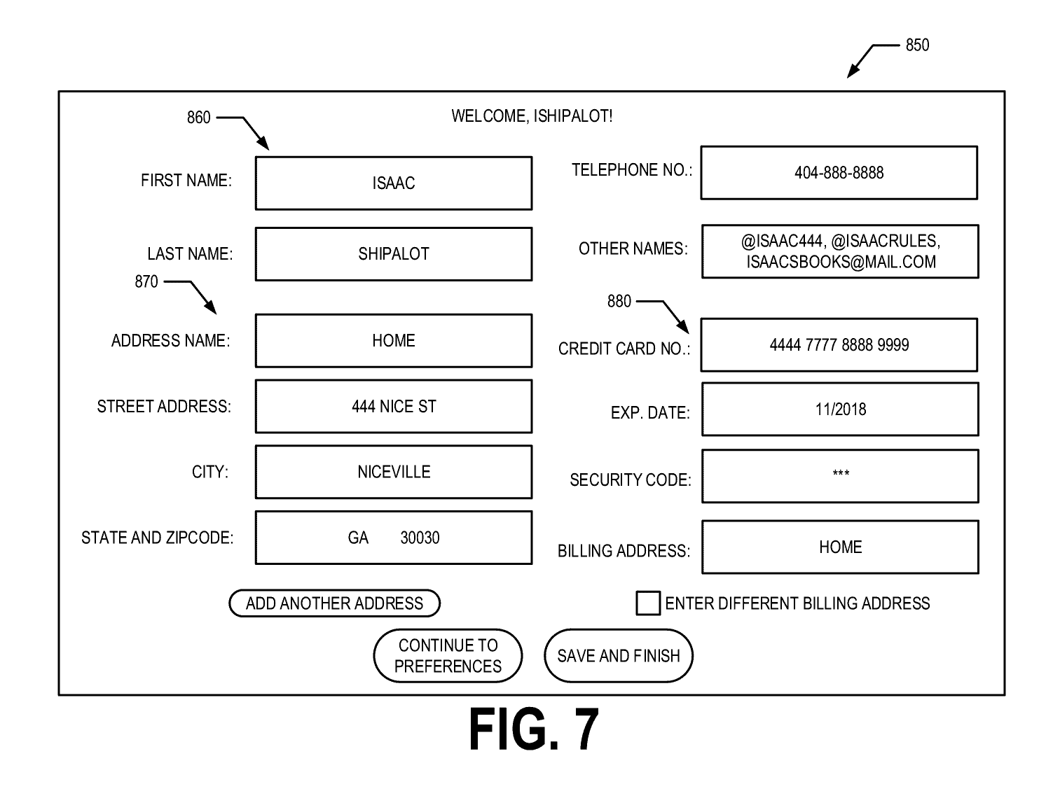

Returning to FIG. 5, at step 404 user information/data is received. For example, the carrier/transporter computing entity 100 may receive user information/data. To do so, the user (e.g., operating a user computing entity 200) may provide input providing and/or indicating user information/data. For instance, the user information/data may comprise address information/data such as one or more delivery addresses, one or more home addresses, one or more work addresses, one or more billing addresses, one or more electronic addresses (e.g., telephone number, instant messaging account identifier, email), and/or the like. The user information/data may further comprise user identifying information/data; billing data; usernames, handles, account names (e.g., social media user/account names), nick names, or other names the user may use in various areas of his/her life (e.g., a user may use his/her first name in his/her professional life and his/her middle name in his/her personal life); delivery, shipping, and/or notification preferences, and/or other preferences. FIG. 7 illustrates an example user information interface 850. As noted above, in various embodiments, the carrier/transporter computing entity 100 may provide a user interface or content executed by an shipping application or browser operating on the user computing entity 200 to provide a user interface configured to request user information/data from a user and receive input from the user comprising and/or indicating user information/data. The user information interface 850 may comprise user identifying information/data form fields 860, address form fields 870, billing data form fields 880, and/or the like. For example, a user may provide input via the user information interface 850 and press/select/click/interact with the save and finish button to save the provided information/data to the user profile and finish the user profile creation/establishment process. In another example, the user may provide input via the user information interface 850 and press/select/click/interact with the continue to preferences button to save the provided information/data and to select and/or provide input indicating user delivery, shipping, notification, and/or other preferences before finishing the user profile creation/establishment process.

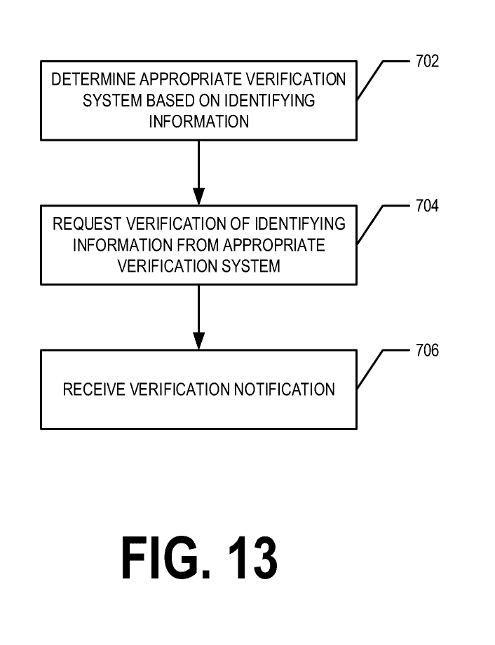

Returning to FIG. 5, at step 406, at least a portion of the user information/data is verified. For example, the carrier/transporter computing entity 100 may request verification of at least a portion of the user information/data from a verification computing entity 300. For example, the carrier/transporter computing entity 100 may identify a telecommunications carrier associated with a telephone that was provided by user input to the user information interface 850. The carrier/transporter computing entity 100 may then contact the telecommunications carrier system (e.g., a verification computing entity 300) to request confirmation of address information/data, billing information/data, and/or other information/data provided by the user as input to the user information interface 850. The carrier/transporter computing entity 100 may, in response to the verification request, receive a verification notification verifying the at least a portion of the user information/data. If the carrier/transporter computing entity 100 does not receive a verification notification (or until the verification notification is received) in response to the verification request, the user information/data may be flagged as being unverified, not yet verified, and/or the like, in some embodiments. The verification process is described in more detail elsewhere herein with regard to FIG. 13. In one embodiment, the carrier/transporter computing entity 100 may verify at least a portion of a user profile based on previous transactions corresponding to the user associated with the user profile (e.g., the previously packages have been delivered to the provided delivery address and addressed to the name provided as the user's name).

Continuing to step 408, the user information/data and any corresponding flags are stored, and the user profile creation/establishment process is completed. For example, the carrier/transporter computing entity 100 may store the user information/data and finish the creation/establishment process for the associated user profile such that the user may use the functionality provided by the user profile. As should be understood, a user may log in (e.g., using the log in information/credentials) and update, change, and/or add to the provided user information/data at the user's convenience. As will be recognized, a variety of other approaches and techniques can be used to adapt to various needs and circumstances.

### 2. Exemplary Shipping Application Set Up

In various embodiments, the carrier/transporter computing entity 100 may provide a shipping application for download, installation and/or the like on a mobile computing device 280 and/or wearable computing device 250. A user may download, install, and/or set up the shipping application on the mobile computing device 280 and/or the wearable computing device 250 such that the user may utilize the functionality of the shipping application to ship one or more items. Using the shipping application, the user may establish one or more shipping profiles. When shipping an item, the user may select the appropriate shipping profile such that shipping information/data may be wirelessly and efficiently transmitted/provided to an establishment computing entity 150 such that the shipping of the item may be facilitated in accordance with the shipping information/data.

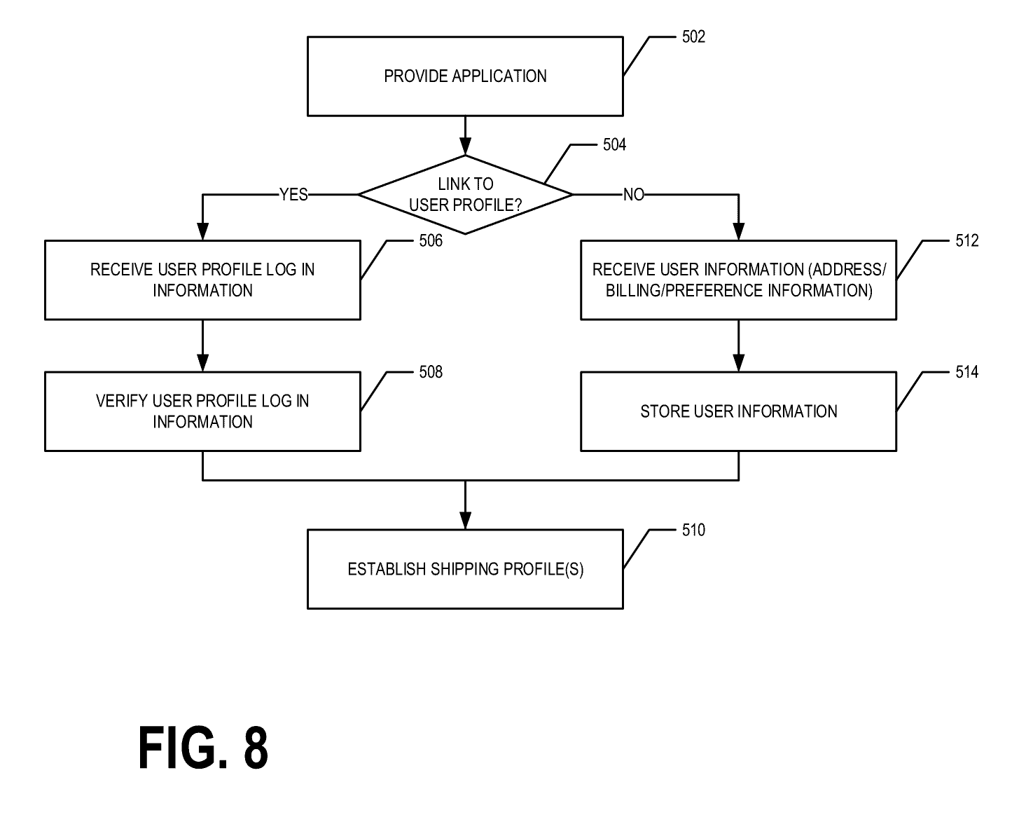

FIG. 8 provides a flowchart illustrating an exemplary shipping application set up process and shipping profile creation/establishment, according to various embodiments of the invention. Starting at step 502, the shipping application is provided. For example, the carrier/transporter computing entity 100 may provide the shipping application for download onto a mobile computing device 280 and/or a wearable computing device 250. In some embodiments, an “app store” may act as an intermediary between the carrier/transporter computing entity 100 and the mobile computing device 280 and/or wearable computing device 250. Thus, the shipping application may be provided, downloaded onto the mobile computing device 280 and/or the wearable computing device 250, and installed thereon for execution by a processing element thereof. The shipping application may be configured to guide a user through the creation of one or more shipping profiles, facilitate the shipping of one or more items, execute one or more shipping notifications to provide at least a portion of the shipping notification(s) to the user, and/or the like.

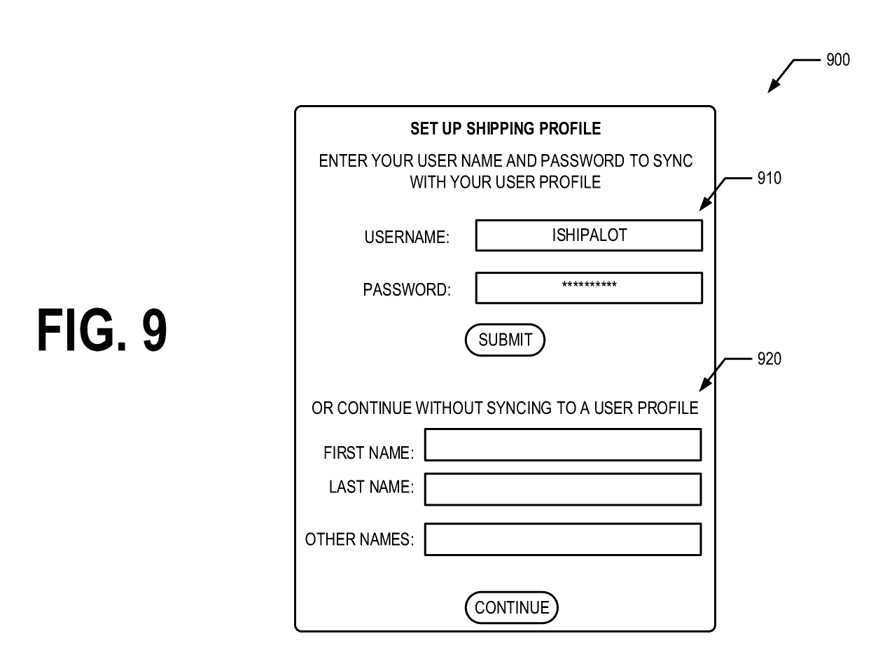

At step 504, it may be determined if the shipping application is to be linked/synced to a user profile. For example, the shipping application may guide a user to link/sync a user profile (e.g., as created/established at step 400) to the shipping application. However, the user may choose to not link/sync the user profile to the shipping application or may not have a user profile to link/sync to the shipping application. Thus, the shipping application may provide the user with a profile linking view 900, an example view of which is shown in FIG. 9. For example, the profile linking view 900 may ask the user (e.g., operating a mobile computing device 280 and/or a wearable computing device 250) if he or she would like to link/sync the shipping application to a user profile. The user may provide input via the profile linking view 900 of the user interface indicating that he or she would or would not like to link/sync a user profile to the shipping application. For example, the user may select/press/click/interact with a yes button or a no button. In another example, as illustrated in FIG. 9, the user may provide the log in credentials for the user profile via the log in credentials form fields 910 and select/press/click/interact with a submit button associated with the log in credentials form fields 910 to indicate that the user would like to link/sync a user profile to the shipping application. If the user does not want to link/sync a user profile to the shipping application, the user may provide input via the user identifying information/data form fields 920 and select/press/click/interact with a continue button associated therewith. Thus, in various embodiments a user (e.g., operating a mobile computing device 280 and/or a wearable computing device 250) may provide input to an shipping application operating on the mobile computing device 280 and/or the wearable computing device 250 indicating whether the user would like to link/sync a user profile with the shipping application or not. The mobile computing device 280, wearable computing device 250, and/or carrier/transporter computing entity 100 may receive the user input provided via the shipping application user interface (e.g., via the profile linking view 900 or the like) and determine whether a user profile is to be linked/synced with the user profile based at least in part on the received input.

If at step 504 it is determined that a user profile is to be linked to the shipping application, the process continues to step 506. At step 506, user profile log in information/credentials are received for the user profile to be linked/synced to the shipping application. For example, the user may provide input via the profile linking view 900 of the user interface including and/or indicating the log in information/credentials for the user profile to be linked/synced to the shipping application. The mobile computing device 280, wearable computing device 250, and/or carrier/transporter computing entity 100 may receive the log in information/credentials provided as input to the user interface.

At step 508, the log in information/credentials are checked to ensure he or she corresponds to a user profile. For example, the carrier/transporter computing entity 100 may check the log in information/credentials to determine whether there is a user profile having/associated with the received log in information/credentials. If there is a user profile having/associated with the received log in information/credentials, the user profile may be linked/synced with the shipping application. If there is not a user profile having/associated with the received log in information/credentials, the carrier/transporter computing entity 100 may provide an error notification that is presented to the user via the shipping application user interface (e.g., via the display of the mobile computing device 280 and/or the wearable computing device 250). By linking/syncing the user profile with the shipping application, the user allows the shipping application to access the user information/data stored in association with the user profile such that the address information/data, billing information/data, user identifying information/data, user preferences information/data may be used to establish one or more shipping profiles via the shipping application and/or the like. Thus, linking/syncing the user profile to the shipping application may reduce the amount of user information/data the user is requested to provide to create/establish one or more shipping profiles. For example, the user information/data stored in association with the user profile may be imported to and/or accessed by the shipping application. Additionally, as at least a portion of the user information/data stored in association with the user profile is verified, the user information/data associated with the shipping profile may not need to be verified when the user utilizes a shipping profile to ship an item.

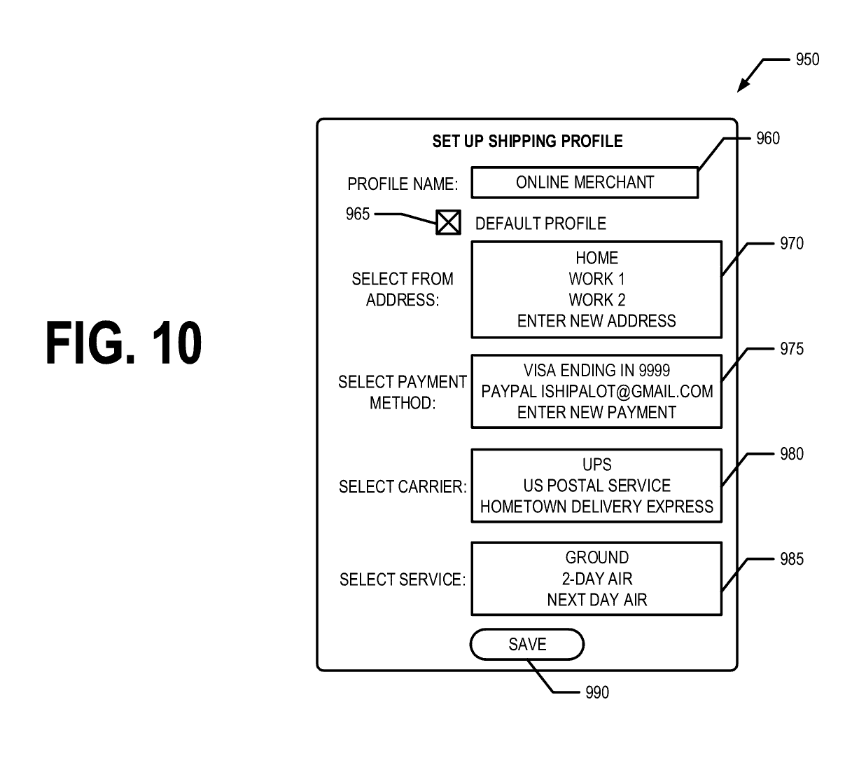

At step 510, one or more shipping profiles may be created/established via the shipping application. For example, the mobile computing device 280 and/or the wearable computing device 250 may create/establish one or more shipping profiles based on the user information/data associated with the user profile and/or user input to the shipping application. FIG. 10 illustrates an example shipping profile creation view 950 of the shipping application. For example, the shipping profile creation interface 950 may comprise a profile name form field 960, a default profile indicator 965, an address selector 970, a payment method selector 975, a carrier selector 980, and a service selector 985. Thus, to create/establish a shipping profile, the user (e.g., operating a mobile computing device 280 and/or wearable computing device 250) may enter a profile name via input to the profile name form field 960, select an address of the one or more addresses of the user information/data stored in association with the user profile via input to the address selector 970, and select a payment method from one or more sets of billing information/data stored in association with the user profile via input the payment method selector 970. In various embodiments, the user may also provide input selecting a carrier and/or a service for shipping any items shipped using the shipping profile via input to the carrier selector 980 and/or the service selector 985. The user may then press/select/click/interact with the save button 990 to save the shipping profile. The mobile computing device 280 and/or the wearable device 250 may store the shipping profile information/data for later use.

In various embodiments, a user may create/establish multiple shipping profiles. For example, the user may create/establish a personal use shipping profile, a work-related shipping profile, and a shipping profile for the user's side business selling used books via an online marketplace. When the user goes to ship an item, the user may select the appropriate shipping profile to be able to efficiently provide electronic shipping information/data corresponding to the item to an establishment computing entity 150.

Returning to FIG. 8, if at step 504 it is determined that the user does not want to link/sync the shipping application to a user profile, the process may continue to step 512. At step 512 user information/data is received. For example, the carrier/transporter computing entity 100 may receive user information/data. For example, the user (e.g., operating a mobile computing device 280 and/or wearable computing device 250) may provide input providing and/or indicating user information/data. For example, the user information/data may comprise address information/data such as one or more delivery addresses, one or more home addresses, one or more work addresses, one or more billing addresses, one or more electronic addresses (e.g., telephone number, instant messaging account identifier, email), and/or the like. The user information/data may further comprise user identifying information/data; billing data; usernames, handles, account names (e.g., social media user/account names), nick names, or other names the user may use in various areas of his/her life (e.g., a user may use his/her first name in his/her professional life and his/her middle name in his/her personal life); delivery, shipping, and/or notification preferences, and/or other preferences. For example, an information/data request form similar to that shown in FIG. 7 may be displayed via the shipping application executing on the user's mobile computing device 280 and/or wearable computing device 250. In various embodiments, the information/data request form may be optimized for the platform on which the shipping application is operating. The user (e.g., operating the user computing device 280 and/or wearable computing device 250) may provide information/data by providing user input to one or more form fields and/or information/data selectors via an interface provided by the shipping application.

At step 514, the user information/data is stored by the shipping application. For example, the user information/data may be stored locally by the mobile computing device 280 and/or the wearable computing device 250. In some embodiments, the user information/data is communicated/provided to the carrier/transporter computing entity 100 and stored thereby. In some embodiments at least a part of the user information/data may be verified. However in various embodiments, the user information/data received via the shipping application is not verified until the user ships an item and/or is the consignee/recipient to which an item is to be delivered. The process then continues to step 510 wherein one or more shipping profiles are established, as described above.

### 3. Exemplary Shipping of an Item

After a user has installed the shipping application on his/her mobile computing device 280 and/or wearable computing device 250, the user may ship an item. For example, a user may enter an establishment location with the item, tender the item to a clerk/customer assisting individual associated with the establishment location or an unmanned receiver of items associate with the establishment computing entity 150. The user may cause the mobile computing device 280 and/or the wearable computing device 250 to provide/transmit electronic shipping information/data corresponding to the item to the establishment computing entity 150 (e.g., via transmission of a short range wireless communication). The carrier/transporter computing entity 100 may verify location information/data corresponding to historical, current, or predicted physical location data for either the mobile computing device 280, the wearable computing device 250, or both. The establishment computing entity 150 may verify at least a portion of the electronic shipping information/data corresponding to the item, provide the shipping information/data to the carrier/transporter computing entity 100, print a label to be affixed to the item, prepare an RFID tag to be affixed to the item, and/or the like.

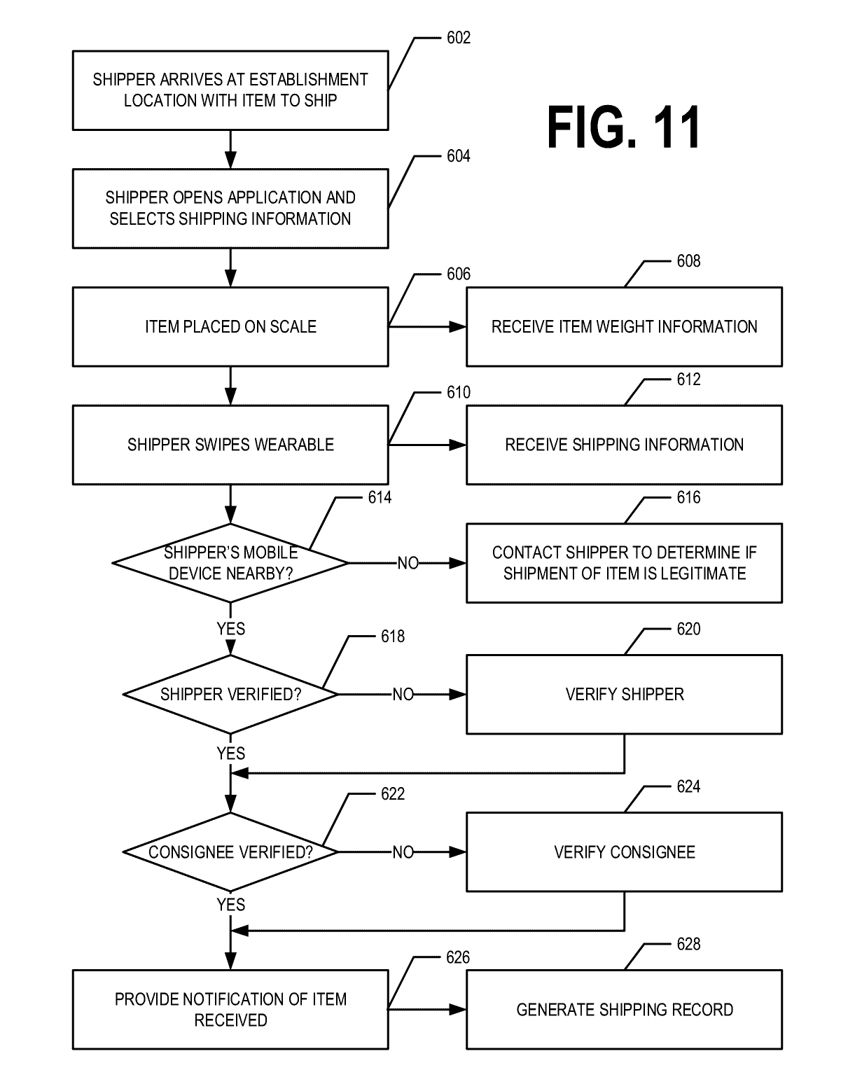

FIG. 11 provides a flowchart illustrating some processes and procedures that may be used in various embodiments in the shipping of an item by a shipper/consignor to a consignee. Starting at step 602, a user arrives at an establishment location with an item to be shipped. For example, the establishment location may be a post office operated by the USPS, a UPS store or other carrier store, a convenience store, drug store, and/or other establishment that may or may not have shipping lockers located thereat. In one embodiment, the establishment location is an unmanned shipping locker location.

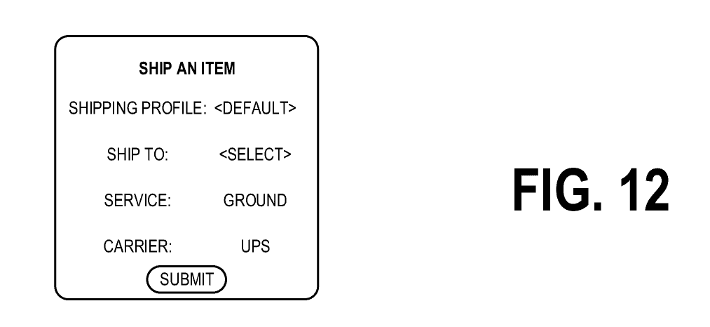

At step 604, the user (e.g., operating the mobile computing device 280 and/or the wearable computing device 250) selects the shipping information/data corresponding to the item. For example, the shipping application executing on the mobile computing device 280 and/or wearable computing device 250 may cause display of a shipping information/data selection interface, similar to that shown in FIG. 12. For example, the user may be asked to select a shipping profile, a carrier, a service level, and a consignee. For example, the user may select a pre-established shipping profile or may choose to make a new shipping profile as described above with respect to step 510. In various embodiments, the shipping application may automatically select the shipping profile selected as the default shipping profile such that a user need only provide input selecting a shipping profile if the user desires to use a shipping profile other than the default shipping profile. In some embodiments, the user may select a carrier and/or a service level for the item. In other embodiments, the carrier and/or service level may be indicated/determined by the selected shipping profile. The user may further select a consignee/recipient to whom the item is to be delivered. In various embodiments, the user may provide input identifying the consignee. For example, one or more form fields may be provided for a user to enter a consignee/recipient name, address, or other consignee/recipient identifying information. For example, the user may only know the consignee's telephone number, email, or a username, handle, and/or the like. In some embodiments, the user may select the consignee/recipient from a list of contacts stored on the user's mobile computing device 280 and/or wearable computing device 250. In one embodiment, the user may select the consignee/recipient identifying information/data from an email, text message, and/or the like accessible via the mobile computing device 280 and/or wearable computing device 250. Thus, continuing with FIG. 11, at step 604, the user (e.g., operating the mobile computing device 280 and/or wearable computing device 250) selects the shipping information/data for the item.

At step 606, the item is placed on a scale or other physical input device 160. The physical input device may be in wired or wireless communication with the establishment computing entity 150 and configured to determine a weight and/or other physical characteristic (e.g., volume, dimensions, etc.) of an item. At step 608, the weight information/data is received. For example, the establishment computing entity 150 may receive the weight information/data from the physical input device 160 and provide the weight information/data to the carrier/transporter computing entity 100. In an example embodiment, the physical input device 160 may also provide the location information/data corresponding to the current physical location of the physical input device that may be used to determine if the user computing device 200, mobile computing device 280, and/or wearable computing device 250 is in the vicinity of the establishment location.

At step 610, the user may swipe the mobile computing device 280 and/or wearable computing device 250 at a near field communication (NFC) reader or otherwise cause the mobile computing device 280 and/or wearable computing device 250 to provide/transmit the electronic shipping information/data to the establishment computing entity 150. For example, the user may press/select/click/interact with a send shipping information/data button provided by the shipping application. In response thereto, the mobile computing device 280 and/or wearable computing device 250 may transmit/provide the shipping information/data to the establishment computing entity 150. In various embodiments, the shipping information/data is provided/transmitted via Bluetooth, Bluetooth low energy, NFC, infrared, ZigBee, infrared, ultra-wideband, and/or other short range communication method. At step 612, the electronic shipping information/data is received. For example, the establishment computing entity 150 may receive the shipping information/data and provide the shipping information/data to the carrier/transporter computing entity 100. In various embodiments, the weight information/data corresponding to the item is associated with the received shipping information/data corresponding to the item. The establishment computing entity 150 may provide the weight information/data with the shipping information/data, rather than sequentially providing the information/data corresponding to the item.

At step 614, it may be determined whether a computing device associated with the user is physically in the vicinity of the establishment. For example, the carrier/transporter computing entity may determine if a computing device associated with the user (in addition to the computing device that provided the shipping information/data by transmitting the short range wireless communication received by the short range receiver 170) is physically within the vicinity of the establishment location. For example, the shipper/consignor may use a wearable computing device 250 to provide the shipping information/data to the short range receiver 170. The wearable computing device 250 may or may not be paired to a mobile computing device 280. The carrier/transporter computing entity 100 may request the location of the mobile computing device 280 to determine if the mobile computing device 280 is also in the vicinity of the establishment location. For example, the carrier/transporter computing entity 100 may request the shipping application installed on the mobile computing device 280 to access a location sensor (e.g., a GPS receiver) of the mobile computing device 280 to provide the location of the mobile computing device 280. To various embodiments, the carrier/transporter computing entity 100 may request the wearable computing device 250 to determine if the paired mobile computing device 280 is within range of short range communications (e.g., 30 feet) of the wearable computing device 250 or if the mobile computing device 280 was recently within range of short range communications (e.g., the wearable computing device 250 received a short range communication from the mobile computing device 280 within the last 10 minutes, last 15 minutes, last half an hour, last hour, and/or the like). If the mobile computing device 280 is located in the vicinity of the establishment location (e.g., based on a known location of the establishment location, and/or location information/data received from the physical input device 160, establishment computing entity 150, and/or the like), the carrier/transporter computing entity 100 may determine that the transaction is legitimate.

In some embodiments, a user profile and/or a shipping profile may be associated with a vehicle (e.g., a user's car or truck) having a GPS receiver or other location sensor associated therewith. In such embodiments, the carrier/transporter computing entity 100 may communicate with the vehicle to request location information/data associated with the vehicle to determine if the vehicle is in the vicinity of the establishment location (e.g., parked in the parking lot outside of the establishment location, within a quarter or a third of a mile of the establishment location, within a predefined geofence of the establishment location, and/or the like). If the vehicle is within the vicinity of the establishment location, the carrier/transporter computing entity 100 may determine that the transaction is legitimate. In various embodiments, the location of other user computing entities having location determination abilities (e.g., having a GPS receiver or other location sensor and/or having historical, real-time, and/or predicted location information/data available) may be determined (e.g., the carrier/transporter computing entity 100 may request location information/data therefrom) to determine whether the transaction is legitimate. For example, historical, real-time, and/or predicted location information/data may be used to verify the identity of the user/shipper/consignor presenting the item for shipment at the establishment location. In various embodiments, the computing device for which the location information/data is determined is identified based at least in part on the consignor identifying information/data provided as part of the shipping information/data and/or a shipping profile or user profile identified by the consignor identifying information/data.

If, at step 614, it is determined that the mobile computing device 280 or other user computing device 200, vehicle, and/or the like is not in the physical vicinity of the establishment (e.g., within a predefined geofence around the establishment location, within a predefined radius of the establishment location, within a predefined range of the location of the physical input device 160 and/or the establishment computing device 150, and/or the like), it may be determined that the transaction may or may not be legitimate and the process continues to step 616. At step 616, the carrier/transporter computing entity 100 or an employee or associate of the carrier/transporter may contact the user identified as the shipper/consignor of the item in the shipping information/data to ask if the user intended to ship the item.

If, at step 614, it is determined that the shipment is legitimate, the process continues to step 618. At step 618, it may be determined whether the shipper/consignor of the item is verified. For example, the carrier/transporter computing entity 100 and/or the establishment computing entity 150 may determine whether the shipper/consignor of the item is verified. For example, it may be determined whether at least a portion of the user identifying information/data associated with the shipper/consignor of the item is verified. For example, it may be determined whether a verified user profile exists that corresponds to the shipper/consignor of the item. For example, the shipping information/data may comprise shipper/consignor identifying information/data that comprises a user profile identifier configured to uniquely identify a user profile. In another example, the shipping information/data may comprise a pre-verified flag indicating that at least a portion of the shipper/consignor identifying information/data has been previously verified. If, at step 618, it is determined that none of the shipper/consignor identifying information/data has been verified or otherwise determined that the shipper/consignor identifying information/data should be verified, the process continues to step 620. At step 620, at least a portion of the shipper/consignor identifying information/data is verified. For example, the carrier/transporter computing entity 100 may request verification of at least a portion of the shipper/consignor identifying information/data. Additional discussion regarding verification of user/shipper identifying information/data is provided below.

If, at step 618, it is determined that the at least a portion of the shipper/consignor identifying information/data has been verified and/or otherwise determined that the shipper/consignor identifying information/data need not be verified, the process continues to step 622. At step 622, it may be determined whether a delivery address for the consignee/recipient of the item is known and/or verified and/or whether at least a portion of the identifying information/data for the consignee/recipient is verified. For example, the carrier/transporter computing entity 100 and/or the establishment computing entity 150 may determine whether the consignee/recipient of the item is verified. For example, it may be determined whether at least a portion of the user identifying information/data associated with the consignee/recipient of the item is verified. For example, it may be determined whether a verified user profile exists that corresponds to the consignee/recipient of the item. For example, the shipping information/data may comprise consignee/recipient identifying information/data that comprises a user profile identifier configured to uniquely identify a user profile and/or other information/data that may be used to identify a user profile. For example, a user profile may comprise a listing of usernames, telephone number, or email address for the user. If the consignee/recipient identifying information/data comprises a username, telephone number, and/or email address that matches a username, telephone number, and/or email address associated with a user profile, it may be determined that the user profile corresponds to the consignee/recipient of the item. In another example, it may be determined whether an address for the consignee/recipient of the item is known. For example, the consignee/recipient identifying information/data provided as part of the shipping information/data corresponding to the item may or may not include a delivery address for the item. Thus, if the consignee/recipient identifying information/data does not comprise a delivery address to which the item is to be delivered, it may be determined whether a user profile corresponds to the consignee. If, at step 622 it is determined that none of the consignee/recipient identifying information/data has been verified, that a delivery address for the item is not known, or otherwise determined that the consignee/recipient identifying information/data should be verified, the process continues to step 624. At step 624 at least a portion of the consignee/recipient identifying information/data is verified. For example, the carrier/transporter computing entity 100 may request verification of at least a portion of the shipper/consignor identifying information/data. Additional discussion regarding verification of user/consignee identifying information/data and/or requesting a consignee/recipient address is provided below. Thus, in various embodiments, both a historical, current, or predicted physical location of user/shipper (and/or the physical location of a computing entity/device associated with the user) is verified and at least a portion of user/shipper and/or consignor/recipient identifying information is verified.

At step 626, a notification of the receipt of the item is provided. For example, the carrier/transporter computing entity 100 may provide/transmit a notification. In various embodiments, the mobile computing device 280 and/or wearable computing device 250 may receive the notification, the shipping application may execute the notification and display the notification. In various embodiments the notification may comprise an acknowledgement that the shipping information/data has been received, the item has been received, the consignee/recipient and/or shipper/consignor has been verified, and/or the like. In various embodiments, the notification may comprise tracking information, a unique item identifier corresponding to the item, delivery information/data (e.g., expected/confirmed delivery date and/or time window) and/or the like. In various embodiments, a notification may be provided to the shipper/consignor and/or the consignee/recipient of the item.

At step 628, a shipping record is generated. For example, the carrier/transporter computing device 100 may generate an electronic shipping record. In various embodiments, the shipping record may be configured to facilitate transportation and/or delivery of the item in accordance with the shipping information/data. For example, the carrier/transporter computing entity 100 may facilitate the transportation and delivery of the item in accordance with the corresponding shipping information/data. In various embodiments, the carrier/transporter computing device 100 may cause a printer or other device (e.g., an RFID encoder) to print a label, encode an RFID tag, and/or the like comprising at least a portion of the shipping information/data provided thereon in human and/or machine readable form. The label, RFID tag, and/or the like may be affixed to the physical item (if not already embedded within the item or item packaging) by the shipper, a personnel of the establishment location, or automatically. For example, a conveyor belt may cause the item to pass under a sticker placing machine configured to affix a label or RFID tag to the item via a sticker and/or the like.

### 4. Exemplary Verification

In various embodiments, the carrier/transporter computing entity 100 may provide a verification request to a verification computing entity 300. For example, based on the user/shipper/consignee identifying information/data provided (e.g., via the user computing entity 200, mobile computing device 280, and/or wearable computing device 250), the carrier/transporter computing entity 100 may request verification of an address, billing information/data, and/or the like. For example, the carrier/transporter computing entity 100 may request verification of billing information/data from a bank/credit union, payment processing system, and/or the like. In another example, the carrier/transporter computing entity 100 may request verification of a user's association with a provided address. In yet another example, the carrier/transporter computing entity 100 may request an address for a user/shipper/consignee based on provided user/shipper/consignee identifying information/data. FIG. 13 provides a flowchart of various processes and procedures that may be used to verify user/shipper/consignee identifying information.

Starting at step 702, the appropriate verification computing system 300 is determined. For example, the carrier/transporter computing entity 100 may determine the appropriate verification computing system 300 from which verification should be requested. For example, the appropriate verification computing system 300 may be determined based at least in part on the provided user/shipper/consignee identifying information/data. For example, if the provided user/shipper/consignee identifying information/data comprises a phone number, it may be determined that the appropriate verification computing system 300 may be a computing system associated with the phone service provider associated with the provided phone number. If the provided user/shipper/consignee identifying information/data comprises a username for a social media account for a social media platform, the appropriate verification computing system 300 may be a computing system associated with the social media platform. For example, an appropriate verification computing entity 300 may be operated by and/or on behalf of a telecommunications company that provides telephone service (e.g., PSTN and/or VOIP, cellular/mobile telephone service, and/or the like), a carrier or transporter (e.g., USPS, Amazon, etc.), a banking services provider (e.g., bank, credit union, payment processing system), the provider of a social media platform, and/or the like.

At step 704, after and/or in response to determining the appropriate verification computing system 300, verification of user/shipper/consignee identifying information/data may be requested. For example, the carrier/transporter computing entity 100 may request verification of user/shipper/consignee identifying information/data from the appropriate verification computing system 300. For example, the carrier/transporter computing entity 100 may provide/transmit a request for verification of user/shipper/consignee to the appropriate verification computing system 300. In various embodiments, the request for verification may comprise at least a portion of the user/shipper/consignee identifying information/data, a request for an address associated with the user/shipper/consignee identified by the user/shipper/consignee identifying information/data, and/or the like.

At step 706, a verification notification is received. For example, the carrier/transporter computing entity 100 may receive a verification notification. For example, the appropriate verification computing entity 300 may respond to the request for verification by providing a verification notification. In various embodiments, the verification notification may simply indicate that the user/shipper/consignee identifying information/data provided in the verification request has been verified (e.g., matches a record stored by and/or accessible to the appropriate verification computing system 300). In some embodiments, the verification notification may comprise user/shipper/consignee identifying information/data. For example, the verification notification may comprise an address associated with the user/shipper/consignee identifying information/data provided in the verification request. For example, if the consignee/recipient identifying information/data does not comprise a delivery address, the request for verification may comprise a request for an address associated with the consignee/recipient identifying information/data and the verification notification may comprise an address associated with the consignee/recipient identifying information/data.

In various embodiments, the carrier/transporter computing entity 100 may store the verification notification and/or may store an indication that the user/shipper/consignee identifying information/data has been verified. In this way, in some embodiments, the carrier/transporter computing entity 100 need only verify a particular user/shipper/consignee identifying information/data once. For example, a user profile may be flagged with an indication that the user information/data has been verified. If shipper/consignee identifying information/data is not associated with a user profile, the carrier/transporter computing entity 100 may establish a shipper/consignee profile that may be converted into a user profile at some point in the future and save an indication that the shipper/consignee identifying information/data stored in association with the shipper/consignee profile has been verified. For example, a shipper/consignee profile may be similar to a user profile but may not be associated with a user profile log in information/credentials.

In various embodiments, the verification of a shipper/consignor may further comprise determining the physical location of the shipper/consignor and/or one or more computing devices associated with the shipper, similar to as described above with respect to step 614. For example, historical, real-time/current, and/or predicted location information/data indicating the historical, real-time, and/or predicted physical location of the user/shipper may be compared against a known location of an establishment location, the current location of a physical input device, and/or the like. In an example embodiment, the item 103 may provide location information/data to the carrier/transporter computing entity 100 (e.g., possibly via the establishment computing entity 150) and the physical location of the item 103 may be confirmed to be within a predetermined range/geofence of the establishment location, physical input device 160, and/or the like.

Thus, in various embodiments, verification of the user/shipper/consignor may comprise a combination of verifying the physical location of the user/shipper/consigner and/or the physical location of a computing device/entity associated therewith (e.g., with respect to the location of establishment location, the physical input device 160, the item 103, and/or the like) and verifying the identity of the user/shipper/consignor (e.g., mailing or physical address, billing information, and/or the like).

### 5. Exemplary Use Cases

Select uses cases are provided below to assist in understanding embodiments of the present invention.

a. Exemplary Use Case 1: Both Shipper/Consignor and Consignee/Recipient are Associated with User Profiles

In the first example use case, both the shipper/consignor and consignee/recipient of an item have previously established user profiles and the user profiles (and/or the associated user identifying information) have been verified. The shipper/consignor of the item has linked the shipping application to the shipper's user profile. The shipper/consignor of the item enters an establishment location with the item and hands the item to a clerk/customer assisting individual at the establishment location. The clerk/customer assisting individual places the item on a scale 160. The shipper/consignor selects the shipping information/data via the shipping application on the shipper's wearable computing device 250 (e.g., an apple watch) and swipes the wearable computing device 250 in the vicinity of a short range receiver 170, thereby enabling a short range wireless communication between the wearable computing device 250 and the short range receiver 170. The establishment computing entity 150 receives item weight information/data from the scale 160 and the shipping information/data from the short range receiver 170.

The shipping information/data comprises consignee/recipient identifying information/data. For example, the consignee/recipient identifying information/data comprises a twitter username. The establishment computing entity 150 forwards/provides/transmits the shipping information/data to the carrier/transporter computing entity 100. The carrier/transporter computing entity 100 determines that the twitter username is associated with a user profile. The carrier/transporter computing entity 100 determines/identifies a delivery address for the item based on the address information/data stored in association with the user profile associated with the twitter username.

The carrier/transporter computing entity 100 generates an electronic shipping record for the item to be shipped comprising at least a portion of the shipping information/data and may additionally cause a printer in the vicinity of the establishment computing entity 150 to print a label for the item. The clerk/customer assisting individual affixes the label to the item. The carrier/transporter computing entity 100 provides a notification to the shipper/consignor of the item and the consignee/recipient of the item indicating that the item has been received and will be transported and delivered in accordance with the provided shipping information/data. The transportation and delivery of the item in accordance with the provided shipping information/data is then facilitated.

b. Exemplary Use Case 2: The Shipper/Consignor is Associated with a User Profile and the Consignee/Recipient is not

In this second example, the shipper/consignor is associated with a user profile and has linked the shipping application installed on the shipper's mobile computing device 280 and/or wearable computing device 250 to the user profile. Thus, the shipper/consignor identifying information/data has already been verified. The shipper/consignor of the item enters an establishment location with the item and places the item in an item receiver associated with an unmanned establishment computing entity 150. The shipper/consignor selects the shipping information/data via the shipping application on the shipper's wearable computing device 250 and swipes the wearable computing device 250 in the vicinity of a short range receiver 170. The establishment computing entity 150 receives the shipping information/data from the short range receiver 170 via a short range wireless communication. The receipt of the shipping information/data triggers a scale 160 associated with the item receiver to capture and provide weight information/data corresponding to the item to the establishment computing entity 150.

The shipping information/data comprises consignee/recipient identifying information/data. For example, the consignee/recipient identifying information/data comprises a phone number. The establishment computing entity 150 forwards/provides/transmits the shipping information/data to the carrier/transporter computing entity 100. The carrier/transporter computing entity 100 determines that the phone number is not associated with a user/shipper/consignee profile. The carrier/transporter computing entity 100 then determines an appropriate verification computing entity 300. For example, the carrier/transporter computing entity 100 determines the phone service provider associated with the phone number and provides/transmits a request for verification to a verification computing entity 300 associated with the phone service provider. The request for verification comprises the telephone number.

The carrier/transporter computing entity 100 receives a verification notification. The verification notification comprises an address associated with the telephone number. For example, the verification notification may comprise the address to which the service for the telephone number is billed. The carrier/transporter computing entity 100 may establish a consignee/recipient profile for the consignee/recipient and store in association therewith the telephone number and the address provided in the verification notification.

Additionally, the carrier/transporter computing entity 100 may identify a mobile computing device 280 paired to the shipper's wearable computing device 250 via the shipping application stored thereon. The carrier/transporter computing entity 100 may then request the location of the mobile computing device 280. In particular, the carrier/transporter computing entity 100 requests (e.g., via the shipping application installed on the mobile computing device 280) that the mobile computing device 280 transmit location information (e.g., determined by a GPS or other location sensor of the mobile computing device 280) indicating the current location of the mobile computing device 280. The carrier/transporter computing entity 100 may then determine, based on received location information, if the mobile computing device 280 paired with the user's wearable computing device 250 is in the vicinity of the establishment location (e.g., in the shipper's pocket, in the shipper's car parked outside the establishment location, and/or the like). After and/or in response to determining that the mobile computing device 280 paired with the wearable computing device 250 is also in the vicinity of the establishment location, the carrier/transporter computing entity 100 determines that the transaction is legitimate.

The carrier/transporter computing entity 100 generates an electronic shipping record for the item to be shipped comprising at least a portion of the shipping information/data and may additionally cause an RFID encoder to store identifying information/data for the item to an RFID tag (e.g., a unique item identifier). The RFID tag is then affixed to the item via an automated process completed by the item receiver and/or the like. The carrier/transporter computing entity 100 provides a notification to the shipper/consignor of the item indicating that the item has been received, a delivery address has been identified, and the item will be transported and delivered in accordance with the provided shipping information/data. The transportation and delivery of the item in accordance with the provided shipping information/data is then facilitated.

c. Exemplary Use Case 3: Both the Shipper/Consignor and the Consignee/Recipient are not Associated with User Profiles

In this third example, neither the shipper/consignor nor the consignee/recipient are associated with a user profile. The shipper/consignor of the item enters an establishment location with the item and hands the item to a clerk/customer assistance individual at the establishment location. The clerk/customer assistance individual places the item on a scale 160. The shipper/consignor selects the shipping information/data via the shipping application on the shipper's wearable computing device 250 and swipes the wearable computing device 250 in the vicinity of a short range receiver 170, thereby causing the short range receiver 170 to receive the shipping information/data from the wearable computing device 250 via a short range wireless communication. The establishment computing entity 150 receives the shipping information/data from the short range receiver 170 and the weight information/data from the scale 160.

The establishment computing entity 150 may forward/provide the shipping information/data to the carrier/transporter computing entity 100. The shipping information/data comprises shipper/consignor identifying information/data and billing information/data. The carrier/transporter computing entity may identify/determine a bank services provider associated with the billing information/data and provide/transmit a request for verification to a verification computing entity 300 associated with the bank services provider. The carrier/transporter computing entity 100 may receive a verification notification from the verification computing entity in response to the request for verification. The carrier/transporter computing entity 100 may then identify a mobile computing device 280 paired to the shipper's wearable computing device 250 via the shipping application stored thereon. The carrier/transporter computing entity 100 may then request the current physical location of the mobile computing device 280. In particular, the carrier/transporter computing entity 100 requests (e.g., via the shipping application installed on the wearable computing device 250) that the wearable computing device 280 determine if the paired mobile computing device 280 is or has recently been (e.g., within the last half an hour or hour) in the vicinity (e.g., within short range communication range) of the wearable computing device 250. The carrier/transporter computing entity 100 also requests (via the shipping application installed on the mobile computing device 280) location information/data indicating the current location of the mobile computing device 280. When it is determined that the mobile computing device 280 paired with the wearable computing device 250 is also in the vicinity of the establishment location (e.g., in the shipper's pocket, in the shipper's car parked outside the establishment location, and/or the like), the carrier/transporter computing entity 100 determines that the transaction is legitimate. The carrier/transporter computing entity 100 may establish a shipper/consignor profile and store the provided shipper/consignor identifying information/data and/or billing information/data in association therewith.

The shipping information/data also comprises consignee/recipient identifying information/data. For example, the consignee/recipient identifying information/data comprises an email address. The carrier/transporter computing entity 100 may determine that the email address is not stored in association with any of the user/shipper/consignee profiles. The carrier/transporter computing entity 100 may then determine an appropriate verification computing entity 300. For example, the appropriate verification computing entity 300 may be a system associated with the email provider of the consignee's email address. The carrier/transporter computing entity 100 may request verification of the consignee/recipient identifying information/data comprising an address associated with the consignee. Rather than receive a verification notification, the carrier/transporter computing entity 100 receives an indication that the email provider does not have a physical address associated with the email address. The carrier/transporter computing entity 100 may then identifying one or more service providers (e.g., the USPS, one or more telephone service providers, one or more power companies, social media platforms, and/or the like) that may have a physical address stored in association with the email address. The carrier/transporter computing entity 100 receives a verification notification from GA Power indicating that GA Power has an account associated with the email address and providing an address associated with the email address. The carrier/transporter computing entity 100 may establish a consignee/recipient profile for the consignee/recipient and store in association therewith the email address and the physical address provided in the verification notification.

The carrier/transporter computing entity 100 generates an electronic shipping record for the item to be shipped comprising at least a portion of the shipping information/data. The carrier/transporter computing entity 100 further causes an RFID encoder to store identifying information/data for the item to an RFID tag (e.g., a unique item identifier). The clerk/customer assistance individual affixes the RFID tag to the item. The carrier/transporter computing entity 100 provides a notification to the shipper/consignor of the item indicating that the item has been received, a delivery address has been identified, and the item will be transported and delivered in accordance with the provided shipping information/data. The carrier/transporter computing entity 100 may also provide an email to the email address indicating that an item has been is being shipped to the address provided in the verification notification and provide a mechanism for the user associated with the email address to change the address to which the item will be shipped if the address provided by the verification notification is incorrect or not the address to which the consignee/recipient would like the item to be delivered. The transportation and delivery of the item in accordance with the provided shipping information/data is then facilitated.

### IV. CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for shipping an item, the method comprising:
receiving shipping information for the item via a short range wireless communication from a user computing device executing a shipping application, the shipping information comprising (a) consignor identifying information and (b) consignee identifying information, the shipping information provided by the shipping application;
identifying a user computing entity associated with the consignor identifying information;
requesting location information from the user computing entity;
processing the location information to determine if the user computing entity is located in the vicinity of the user computing device; and
responsive to determining that the user computing entity is located in the vicinity of the user computing device, generating a shipping record configured to facilitate the transportation and delivery of the item in accordance with the shipping information.

2. The method of claim 1 further comprising:
requesting verification of the consignor identifying information, the consignee identifying information, or both from a third party computing device;
after requesting verification, receiving a verification notice comprising an address associated with the consignor, an address associated with the consignee, or both; and
wherein the generated shipping record comprises at least one address provided by the verification notice.

3. The method of claim 1 wherein (a) the shipping information does not comprise a delivery address, (b) the verification notice comprises a delivery address for the consignee, and (c) the generated shipping record facilitates delivery of the item to the delivery address provided by the verification notice.

4. The method of claim 1 further comprising, in response to receiving the verification notice, providing a notification to the user computing device and causing display of the notification by the shipping application.

5. The method of claim 1, wherein the user computing device is a wearable computing device.

6. The method of claim 5, wherein the wearable computing device is paired with a mobile computing device.

7. The method of claim 6, wherein the user computing entity is the mobile computing device paired with the wearable computing device.

8. The method of claim 1, further comprising:
receiving weight, dimensions, environmental status information corresponding to the item from an physical input device.

9. The method of claim 1, wherein the short range wireless communication is received via one of Bluetooth, Bluetooth low energy, near field communication, Wi-Fi Direct, infrared, or ultra-wideband.

10. The method of claim 1, wherein the consignor identifying information, the consignee identifying information, or both comprise at least one of a telephone number, an email address, or a social media username.)

11. The method of claim 1, wherein the consignee identifying information is selected from a contacts list stored on the user computing device.

12. The method of claim 1, further comprising, responsive to receiving the verification notification, causing a shipping label to be printed.

13. An apparatus comprising at least one processor and at least one memory including program code, the at least one memory and the program code configured to, with the processor, cause the apparatus to at least:
receive shipping information for an item via a short range wireless communication from a user computing device executing a shipping application, the shipping information comprising (a) consignor identifying information and (b) consignee identifying information, the shipping information provided by the shipping application;
identify a user computing entity associated with the consignor identifying information;
request location information from the user computing entity;
process the location information to determine if the user computing entity is located in the vicinity of the user computing device; and
responsive to determining that the user computing entity is located in the vicinity of the user computing device, generate a shipping record configured to facilitate the transportation and delivery of the item in accordance with the shipping information.

14. The apparatus of claim 13 wherein the at least one memory and the program code are further configured to, with the processor, cause the apparatus to:
request verification of the consignor identifying information, the consignee identifying information, or both from a third party computing device;
after requesting verification, receive a verification notice comprising an address associated with the consignor, an address associated with the consignee, or both; and
wherein the generated shipping record comprises at least one address provided by the verification notice.

15. The apparatus of claim 13 wherein (a) the shipping information does not comprise a delivery address, (b) the verification notice comprises a delivery address for the consignee, and (c) the generated shipping record facilitates delivery of the item to the delivery address provided by the verification notice.

16. The apparatus of claim 13 wherein the at least one memory and the program code are further configured to, with the processor, cause the apparatus to, in response to receiving the verification notice, provide a notification to the user computing device and cause display of the notification by the shipping application.

17. The apparatus of claim 13, wherein the user computing device is a wearable computing device.

18. The apparatus of claim 17, wherein the wearable computing device is paired with a mobile computing device.

19. The apparatus of claim 18, wherein the user computing entity is the mobile computing device paired with the wearable computing device.

20. The apparatus of claim 13 wherein the at least one memory and the program code are further configured to, with the processor, cause the apparatus to receive weight information corresponding to the item from a scale.

21. The apparatus of claim 13, wherein the short range wireless communication is received via one of Bluetooth, Bluetooth low energy, near field communication, Wi-Fi Direct, infrared, or ultra-wideband.

22. The apparatus of claim 13, wherein the consignor identifying information, the consignee identifying information, or both comprise at least one of a telephone number, an email address, or a social media username.

23. The apparatus of claim 13, wherein the consignee identifying information is selected from a contacts list stored on the user computing device.

24. The apparatus of claim 13, wherein the at least one memory and the program code are further configured to, with the processor, cause the apparatus to, responsive to receiving the verification notification, cause a shipping label to be printed.

25. A computer program product comprising at least one non-transitory computer-readable storage medium having computer-readable program code portions stored therein, the computer-readable program code portions comprising:
an executable portion configured to receive shipping information for an item via a short range wireless communication from a user computing device executing a shipping application, the shipping information comprising (a) consignor identifying information and (b) consignee identifying information, the shipping information provided by the shipping application;
an executable portion configured to identify a user computing entity associated with the consignor identifying information;
an executable portion configured to request location information from the user computing entity;
an executable portion configured to process the location information to determine if the user computing entity is located in the vicinity of the user computing device; and
an executable portion configured to, responsive to determining that the user computing entity is located in the vicinity of the user computing device, generate a shipping record configured to facilitate the transportation and delivery of the item in accordance with the shipping information.
